(19) United States
(12) Patent Application Publication
(10) Pub. No.: US 2025/0278861 A1
(43) Pub. Date: Sep. 4, 2025

(54) METHOD TO COLLECT AND FILTER STRUCTURED AND UNSTRUCTURED PRODUCT AND USER DATA USING A ZENCOLOR NESTING CUBE AND SMALL LANGUAGE COLOR MODEL TO GENERATE ARTIFICIAL INTELLIGENCE BASED SERVICES

(71) Applicant: ZENCOLOR GLOBAL, LLC, MIAMI, FL (US)

(72) Inventor: DANN GERSHON, MIAMI, FL (US)

(21) Appl. No.: 19/213,853

(22) Filed: May 20, 2025

Related U.S. Application Data
(63) Continuation-in-part of application No. 18/784,864, filed on Jul. 25, 2024.
(63) Continuation-in-part of application No. 17/525,803, filed on Nov. 12, 2021, now Pat. No. 12,307,720.
Application No. 17/525,803 is a continuation-in-part of application No. 16/594,102, filed on Oct. 7, 2019, now Pat. No. 11,238,617.
Application No. 16/594,102 is a continuation of application No. 15/472,242, filed on Mar. 28, 2017, now Pat. No. 10,460,475.
Application No. 15/472,242 is a continuation-in-part of application No. 15/257,858, filed on Sep. 6, 2016, now Pat. No. 9,607,404.
Application No. 15/257,858 is a continuation-in-part of application No. 14/808,108, filed on Jul. 24, 2015, now Pat. No. 9,436,704.
Application No. 14/808,108 is a continuation-in-part of application No. 14/055,884, filed on Oct. 17, 2013, now Pat. No. 9,348,844.
Application No. 14/055,884 is a continuation of application No. 13/910,557, filed on Jun. 5, 2013, now Pat. No. 8,600,153.
Application No. 13/910,557 is a continuation-in-part of application No. 13/762,160, filed on Feb. 7, 2013, now abandoned.
Application No. 13/762,160 is a continuation-in-part of application No. 13/762,281, filed on Feb. 7, 2013, now abandoned.
Application No. 13/762,281 is a continuation-in-part of application No. 13/857,685, filed on Apr. 5, 2013, now abandoned.
Application No. 13/857,685 is a continuation-in-part of application No. PCT/US13/25135, filed on Feb. 7, 2013.
Application No. PCT/US13/25135 is a continuation-in-part of application No. PCT/US13/25200, filed on Feb. 7, 2013.
Application No. PCT/US13/25200 is a continuation-in-part of application No. PCT/US13/35495, filed on Apr. 5, 2013.
Application No. PCT/US13/35495 is a continuation-in-part of application No. 13/762,160, filed on Feb. 7, 2013, now abandoned.
Application No. 13/762,160 is a continuation-in-part of application No. 13/762,281, filed on Feb. 7, 2013, now abandoned.
Application No. 13/762,281 is a continuation-in-part of application No. 13/762,160, filed on Feb. 7, 2013, now abandoned.
Application No. 13/762,160 is a continuation-in-part of application No. 13/762,281, filed on Feb. 7, 2013, now abandoned.
(60) Provisional application No. 63/528,899, filed on Jul. 25, 2023.
(60) Provisional application No. 63/113,187, filed on Nov. 12, 2020.
(60) Provisional application No. 61/792,401, filed on Mar. 15, 2013.
(60) Provisional application No. 61/679,973, filed on Aug. 6, 2012.
(60) Provisional application No. 61/656,206, filed on Jun. 6, 2012.
(60) Provisional application No. 61/656,206, filed on Jun. 6, 2012.
(60) Provisional application No. 61/679,973, filed on Aug. 6, 2012.
(60) Provisional application No. 61/792,401, filed on Mar. 15, 2013.
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.
(60) Provisional application No. 61/656,206, filed on Jun. 6, 2012.
(60) Provisional application No. 61/679,973, filed on Aug. 6, 2012.
(60) Provisional application No. 61/792,401, filed on Mar. 15, 2013.
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.

(51) Int. Cl. G06T 7/90; G06F 16/583; G06F 18/2431; G06Q 10/087; G06Q 30/0601; G06V 10/56; G06V 10/75; G06V 10/764

(52) U.S. Cl. CPC G06T 7/90; G06F 16/5838; G06F 18/2431; G06Q 10/087; G06Q 30/0627; G06Q 30/0639; G06Q 30/0643; G06V 10/56; G06V 10/751; G06V 10/764; G06T 2207/10024; G06T 2207/20021

(57) ABSTRACT

A computer-implemented method for mapping a RGB digital color space into smaller and more efficient subsets. The smaller subsets are mathematically mapped into a three-dimensional cube model, sides and layers of the cube model become progressively smaller until all sides and layers converge at a center point of the cube model to form a three-dimensional nesting cube. Coordinates in standard RGB digital color space that are not distinguishable to a human eye are consolidated to an appropriated individual mapping cube to provide a color data visualization that is understandable to both a human being and a machine. The three-dimensional nesting cube is organized into equidistant and individual nesting cubes to provide a normalized three-dimensional nesting cube. Each individual cube represents a unique data mapping code of a universal digital small language color model. The normalized three-dimensional nesting cube is mathematically sliced into connecting two-dimensional slices.

### RELATED APPLICATION

The present application is a continuation-in-part application of application Ser. No. 18/784,864 filed Jul. 25, 2024, which claims benefit of Provisional Application No. 63/528,899 filed Jul. 25, 2023, which is incorporated herein by reference in its entirety.

The present application is a continuation-in-part application of application Ser. No. 17/525,803 filed Nov. 12, 2021, which claims benefit of Provisional Application No. 63/113,187 filed Nov. 12, 2020 and is continuation-in-part application of application Ser. No. 16/594,102 filed Oct. 7, 2019, now U.S. Pat. No. 11,238,617, which is a continuation of |application Ser. No. 15/472,242 filed Mar. 28, 2017, now U.S. Pat. No. 10,460,475, which is a continuation-in-part of application Ser. No. 15/257,858 filed Sep. 6, 2016, now U.S. Pat. No. 9,607,404, which is a continuation-in-part of application Ser. No. 14/808,108 filed Jul. 24, 2015, now U.S. Pat. No. 9,436,704, which is a continuation-in-part of application Ser. No. 14/055,884 filed Oct. 17, 2013, now U.S. Pat. No. 9,348,844, which is a continuation of application Ser. No. 13/910,557 filed Jun. 5, 2013, now U.S. Pat. No. 8,600,153, each of which is incorporated herein by reference in its entirety.

Application Ser. No. 13/910,557 is a continuation-in-part of application Ser. No. 13/762,160 filed Feb. 7, 2013, a continuation-in-part of PCT/US13/25135 filed Feb. 7, 2013, a continuation-in-part of application Ser. No. 13/762,281 filed Feb. 7, 2013, a continuation-in-part of PCT/US13/25200 filed Feb. 7, 2013, a continuation-in-part application Ser. No. 13/857,685 filed Apr. 5, 2013, and a continuation-in-part of PCT Application No. PCT/US13/35495 filed Apr. 5, 2013, each of which is incorporated herein by reference in its entirety.

Application Ser. No. 13/857,685 is a continuation-in-part of application Ser. No. 13/762,160 filed Feb. 7, 2013, and a continuation-in-part of application Ser. No. 13/762,281 filed Feb. 7, 2013, each of which is incorporated herein by reference in its entirety.

Application Ser. No. 13/910,557, application Ser. No. 13/857,685, PCT/US13/35495, each of which claims benefit of Provisional Application No. 61/656,206 filed Jun. 6, 2012, Provisional Application No. 61/679,973 filed Aug. 6, 2012, and Provisional Application No. 61/792,401 filed Mar. 15, 2013, each of which is incorporated herein by reference in its entirety.

Application Ser. No. 13/762,281, application Ser. No. 13/762,160, PCT/US13/25135 and PCT/US13/25200, each of which claims priority to Provisional Application No. 61/595,887 filed Feb. 7, 2012, Provisional Application No. 61/656,206 filed Jun. 6, 2012, and Provisional Application No. 61/679,973 filed Aug. 6, 2012, each of which is incorporated herein by reference in its entirety.

PCT/US13/35495 claims priority to application Ser. No. 13/762,160, application Ser. No. 13/762,281, each of which is incorporated herein by reference in its entirety.

### FIELD OF INVENTION

The claimed invention relates to an equidistantly mapped Zencolor nesting cube model, more particularly, a system and method for objectively collecting and filtering both structured and unstructured retail product and user data, for shopping and other services generated by machine learning and artificial intelligence

### BACKGROUND OF THE INVENTION

In 1996, Microsoft and Hewlett Packard introduced a color model, sRGB (Standard Red Green Blue), to standardize color display on analog cathode ray tube (CRT) monitors across the worldwide web, as shown in FIG. 1.

The advent of the Internet created the need to apply color to web-based digital content. In order to map the amorphous RGB color space, it was converted into the shape of a cube. The eight corners on the outer layer of the cube map to the sRGB color space gamut. As shown in FIG. 2, the sRGB cube model, like the CRT monitor, was mapped to 8-bit channels for Red, Green, and Blue (0-255 per channel). This produces 16,777,216 fixed, equidistantly mapped coordinates when the channels are cubed. Where the R, G, and B values intersect (x-y-z) provides a means by which to map the coordinate position to a numeric code.

As technology progressed, CRT monitors were replaced with digital liquid-crystal display (LCD) monitors. RGB remained the universal means to display color on a device. The sRGB picker remained the universal means to apply color to or extract color from digital content. The ability to apply color to digital content became very important as design teams moved to computer-aided designs (CADs) and other digital design tools. Designing products by hand required colored pencils, markers, paints, inks, and other tools to apply color to paper. With the advent of digital content and design tools, designers now required a “digital” crayon. As shown in FIG. 3, sRGB pickers provide that tool. The sRGB coordinate system, however, was not designed to properly align color data between physical and digital assets. It is too random, redundant, and subjective for this purpose.

### OBJECT AND SUMMARY OF THE INVENTION

Therefore, it is an object of the claimed invention to provide a method to collect and filter structure and unstructured product and user data using a Zencolor nesting cube and small language color model to generate artificial intelligence-based services.

In accordance with an exemplary embodiment of the claimed invention, the Zencolor Nesting Cube data mapping model is based on a similar concept as a Russian nesting doll. The dolls are nested inside one another, decreasing in size until one reaches the last doll. The six sides of the claimed Zencolor nesting cube model connect at every layer to form a cube within a cube. These cubes get progressively smaller and smaller until finally reaching the last cube, which is located at the center point (x-axis) of the Zencolor nesting cube structure.

Analog color wheels display 360° of hue. Reconfiguring a circular color wheel produces a linear hue slider. In accordance with an exemplary embodiment of the claimed invention, the gamut of the color wheel is mapped to the six outside hue corners of the sRGB color cube by reconfiguring the two-dimensional view of the outer layers of all six sides of the three-dimensional Zencolor Nesting Cube model.

In accordance with an exemplary embodiment of the claimed invention, a computer-implemented method for mapping a RGB digital color space into smaller and more efficient subsets of the sRGB digital color space. The smaller subsets of the RGB digital color space are mathematically mapped into a three-dimensional cube model, sides and layers of the three-dimensional cube model become progressively smaller until all sides and layers converge at a center point of the three-dimensional cube model to form a three-dimensional nesting cube. Coordinates in a standard RGB (sRGB) digital color space that are not distinguishable to a human eye are mathematically consolidated to an appropriated individual mapping cube to provide a color data visualization that is understandable to both a human being and a machine. The three-dimensional nesting cube is organized into equidistant and individual nesting cubes to provide a normalized three-dimensional nesting cube. Each individual cube of the three-dimensional normalized nesting cube represents a unique and recognizable data mapping code of a universal digital small language color model. The normalized three-dimensional nesting cube is mathematically sliced into connecting two-dimensional slices. Each two-dimensional slice forms a grid mapping the normalized three-dimensional nesting cube to a hue axis corner, a longitude representing a horizontal movement within the grid, a latitude representing a vertical movement within the grid, and a layer representing an equidistant division of corners and midpoint of the grid to the center point of the normalized three-dimensional nesting cube. The unique data mapping code of the normalized three-dimensional nesting cube is defined by the grid mapping to the hue axis corner, the longitude, the latitude and the layer. The color data visualization of a physical product is aligned to a digital image that represents the physical product with the unique data mapping code that corresponds to the universal digital small language color model. A raw RGB image color is normalized into a smaller, more efficient subset of sRGB digital color space. Sticky contextual product data is adhered to the universal digital small language model. Structured and unstructured product data are bucketed into an individual nesting cube of the normalized three-dimensional nest cube to filter and structure the product data. Structured and unstructured user and user preference data are bucketed based on color-based product search queries into the individual nesting cube of the normalized three-dimensional nesting cube to filter and structure the user data. The filtered and structured product and user data are utilized for hyper-personalized search, data analytics, data marketing, and concierge sale service.

In accordance with an exemplary embodiment of the claimed invention, the aforesaid normalized three-dimensional nesting cube comprises following six hue axis corners: a red side with a red hue axis corner, a yellow side with a yellow hue axis corner, a green side with a green hue axis corner, a cyan side with a cyan hue axis corner, a blue side with a blue hue axis corner, and a magneto side with a magneto hue axis corner.

In accordance with an exemplary embodiment of the claimed invention, the aforesaid method further comprises embedding the product metadata to the unique mapping code extracted from the digital image of the physical product and uploading the digital image of the physical product embedded with the product metadata to an eCommerce platform.

In accordance with an exemplary embodiment of the claimed invention, the aforesaid method further comprises homogenizing color data across the eCommerce platform to provide a homogenized eCommerce platform by: matching a digital image of each physical product offered in the eCommerce platform to the unique mapping code that corresponds to the universal digital small language color model; embedding the product metadata to the digital image of said each physical product; and uploading the digital image of said each physical product embedded with the product metadata to the eCommerce platform.

In accordance with an exemplary embodiment of the claimed invention, the aforesaid method further comprises displaying a graphical user interface with a normalized color palette of the data mapping code that corresponds to the universal digital small color language model to an online shopper on the homogenized eCommerce platform so that the online shopper can search for a desired product by the normalized color palette of the data mapping code that corresponds to the universal digital small color language model.

In accordance with an exemplary embodiment of the claimed invention, the aforesaid method further comprises utilizing the normalized three-dimensional nesting cube and the universal digital small color language model to collect an interaction of the online shopper with the homogenized eCommerce platform to collect, filter, and structure the user preference data and the product data.

In accordance with an exemplary embodiment of the claimed invention, the aforesaid method further comprises utilizing the normalized three-dimensional nesting cube and the universal digital small color language model by a machine learning and artificial intelligence engine to collect and filter the product data, the user data and the user preference data generated by the interaction of the online shopper with the homogenized eCommerce platform and to coordinate products on the homogenized eCommerce platform; and generating hyper-personalized and color-coordinated product suggestions based on the mapping code of the desired product.

In accordance with an exemplary embodiment of the claimed invention, the aforesaid method further comprises assigning the unique color mapping code that corresponds to the universal digital color language model to a physical product that is closest to an individual nesting cube of the normalized three-dimensional color nesting cube based on color component intensity values for at least one dominant color of the physical product.

In accordance with an exemplary embodiment of the claimed invention, the aforesaid method further comprises generating retail data analytics and personalized data marketing to online shoppers based on search results and shopping history on an eCommerce platform by a machine learning and artificial intelligence engine.

Various other objects, advantages and features of the present invention will become readily apparent from the ensuing detailed description, and the novel features will be particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-described and other advantages and features of the present disclosure will be appreciated and understood by those skilled in the art from the following detailed description and drawings of which:

FIG. 1 is a standardize color display on analog CRT monitors;

FIG. 2 is a diagram of sRGB color cube;

FIG. 3 is a diagrams of sRGB pickers;

FIG. 4 is a diagram of sRGB color cube to apply color to websites in accordance with an exemplary embodiment of the invention;

FIG. 5 illustrates variations in assigning color attributes for the RGB color cube from human and machine perspective;

FIG. 6 illustrates a three-dimensional view of the sRGB coordinate model;

FIG. 7 illustrates a two-dimensional view of the sRGB coordinate model;

FIG. 8 illustrates a center cube view of sRGB coordinate model;

FIG. 9 illustrates replacement of a coordinate-based model with a cube-based model to eliminate the gaps in the sRGB color cube in accordance with an exemplary embodiment of the invention;

FIG. 10 illustrates Zencolor Nesting Cubes getting progressively smaller and smaller until finally reaching the last cube in accordance with an exemplary embodiment of the claimed invention;

FIG. 11 illustrates the Hue Corners (red, yellow, green, cyan, blue, and magenta) defining the sides of the Zencolor Nesting Cube in accordance with an exemplary embodiment of the claimed invention;

FIG. 12 illustrates the outside hue corners of the RGB cube and Zencolor Nesting Cube model being mapped to the same color gamut in accordance with an exemplary embodiment of the claimed invention;

FIG. 13 illustrates the coordinates in the sRGB color cube that are merged into a new nesting cube format to properly align the sRGB coordinate model in accordance with an exemplary embodiment of the invention;

FIG. 14 illustrates the sRGB coordinates retaining their fixed mapping positions as they are merged into the new nesting cube model in accordance with an exemplary embodiment of the invention;

FIG. 15 illustrates the sRGB coordinates housed within the individual nesting cubes, retaining their orientation to the eight defined corners of both the sRGB cube and the nesting cube models in accordance with an exemplary embodiment of the invention;

FIG. 16 illustrates merging of all 16,777,216 coordinates that comprise the 24-Bit sRGB color cube into the new nesting cube model in accordance with an exemplary embodiment of the invention;

FIG. 17 illustrates mapping from the outer layer of sRGB color cube model to the outer layer of the Zencolor Nesting Cube model in accordance with an exemplary embodiment of the claimed invention;

FIG. 18 illustrates the mapping of the sRGB coordinates to the Zencolor Nesting Cube format creating midpoints in accordance with an exemplary embodiment of the claimed invention;

FIG. 19 illustrates the Zencolor Nesting Cube model comprising six pyramid-like formations that share a common center and a sectional view of the pyramid formation in accordance with an exemplary embodiment of the claimed invention;

FIG. 20 illustrates the layers of the nesting cube converging at the center point (X-Axis) in accordance with an exemplary embodiment of the claimed invention;

FIG. 21 illustrates the interior view of the Zencolor Nesting Cube model, which connects the six sides of the cube at every layer in accordance with an exemplary embodiment of the claimed invention;

FIG. 22 illustrates individual cubes in the Zencolor Nesting Cube model providing the basis for a three-dimensional Cartesian mapping system in accordance with an exemplary embodiment of the claimed invention;

FIGS. 23 illustrates machine views of the color code which is a perfectly balanced and equidistant Cartesian mapping system in accordance with an exemplary embodiment of the invention;

FIG. 24 illustrates the symmetry of the color data mapping language models (ZCC and ZAC) in accordance with an exemplary embodiment of the claimed invention;

FIG. 25 illustrates human and machine visualizations of the physical product;

FIG. 26 illustrates the alignment between the product image to the swatch data to align the color data visualization between a human and a machine in accordance with an exemplary embodiment of the claimed invention;

FIG. 27 illustrates the alignment between the swatch data and the data filter in accordance with an exemplary embodiment of the claimed invention;

FIGS. 28-31 illustrate processes of aligning the color of the physical product to the corresponding product image and data filtering by Zencolor Nesting Cube and color language model to provide hyper-personalized shopping services in accordance with an exemplary embodiment of the claimed invention;

FIGS. 32-34 illustrate data workflows from the Product Lifecycle Management system to the eCommerce platform by Zencolor Nesting Cube and color language model to provide hyper-personalized shopping services in accordance with an exemplary embodiment of the claimed invention;

FIG. 35 is a flowchart of a universal data mapping color language model used to collect and index both digital and non-digital data points for machine learning and Artificial Intelligence in accordance with an exemplary embodiment of the invention;

FIG. 36 is a flowchart of a universal data mapping color language model showing its application to a wide variety of useful applications across all aspects of the product ecosystem that benefits both retailers and consumers in accordance with an exemplary embodiment of the invention;

FIG. 37 is a block diagram of the system in accordance with an exemplary embodiment of the claimed invention;

FIG. 38 is a block diagram of the server in accordance with an exemplary embodiment of the claimed invention; and

FIG. 39 is a block diagram of the client device in accordance with an exemplary embodiment of the claimed invention.

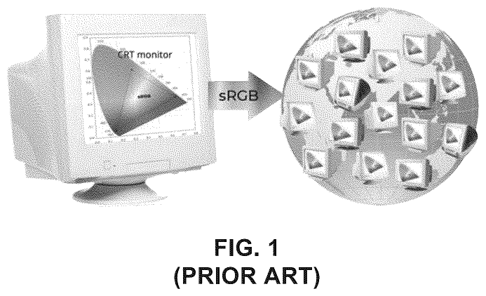

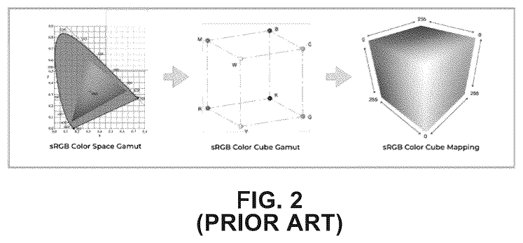

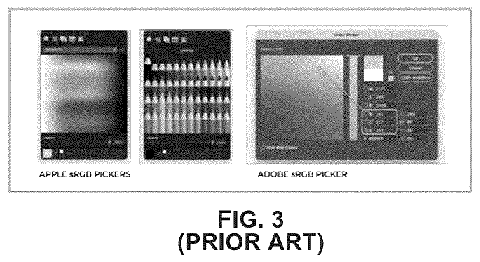

### DETAILED DESCRIPTION OF THE EMBODIMENTS

The color-based data points cannot be indexed or machine learning and artificial intelligence with a universal color language model.

All people see and describe color differently, using a myriad of different words to describe the exact same color. These descriptions are subjective, random, and fail to convey meaning. Further, the multitude of diverse digital and non-digital mediums provide no standardized language to effectively and objectively define vast amounts of structured and unstructured color data that are captured every single day. This makes it impossible to properly index those data points for machine learning and Artificial Intelligence.

While the RGB color space is infinite, the sRGB color cube or coordinate model contains precisely 16,777,216 mapped coordinates. All coordinates are arranged in a fixed position within the eight corners of the color cube. There is no version of the RGB color space that contains less coordinates than the sRGB color picker. It should be noted that there are various interpretations of sRGB, but all are based on a 24-Bit system with 8-Bit channels, one for each value of red, green, and blue. The various versions provide slightly different color attributes, but these attributes are too similar to one another to be differentiated by the human eye. Based on this, the color data becomes subjective. Further, utilizing the same 24-Bit mapping system to describe the color attribute is not meaningful to a machine. The machine cannot separate one version from another as they are all based on exactly the same coordinate mapping system. To some degree, this presents the same problem as using different names to describe exactly the same color. That makes it difficult, if not impossible, to properly define the data.

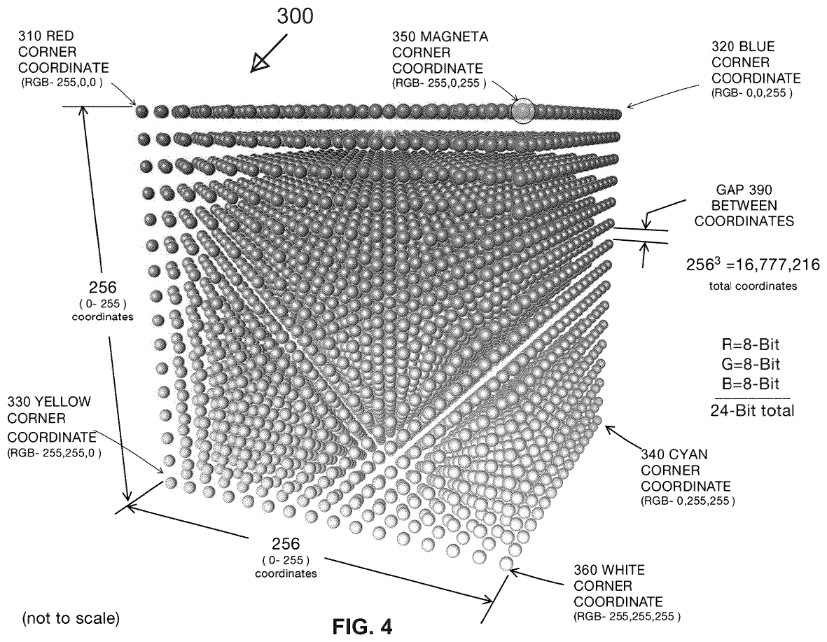

Turning now to FIG. 4, the three-dimensional sRGB color cube 300 has distinct eight corners (Red 310, Green, Blue 320, Yellow 330, Cyan 340, Magenta 350, Black, and White 360). The outside perimeter of the three-dimensional sRGB color cube 300 is comprised of 256 coordinates, numbered from 0 to 255 per channel. The coordinates are measured from corner to corner on the outside layer of the cube, which creates 16,777,216 (256×256×256) unique coordinates in total. While the sRGB color model representation may appear to be solid and cohesive, there are actually “gaps” 390 between all of the coordinates that occupy the three-dimensional cube.

RGB is the native language by which all color is displayed on a digital substrate. It is device dependent. All non-digital color mediums must be converted to RGB in order to display color on a device. As non-digital mediums are subtractive and digital mediums are additive, a conversion from non-digital to digital is, at best, an approximation. The need for a digital color medium, however, is relatively new. sRGB is the world's default color space, developed to display and code digital content for the web. The sRGB color cube was created in 1996 as a means to apply color to websites. The three-dimensional color cube was converted to a two-dimensional color picker that made it easier for both coders and designers to search for and locate a specific sRGB color coordinate. As digital technology improved, however, there was a need for color to display beyond an 8-Bit channel. The sRGB color picker, based on the 8-Bit RGB channels, remained in computer aided design (CAD) and drawing programs as a means for designers and coders to select and communicate digital color palettes. It is still in use today.

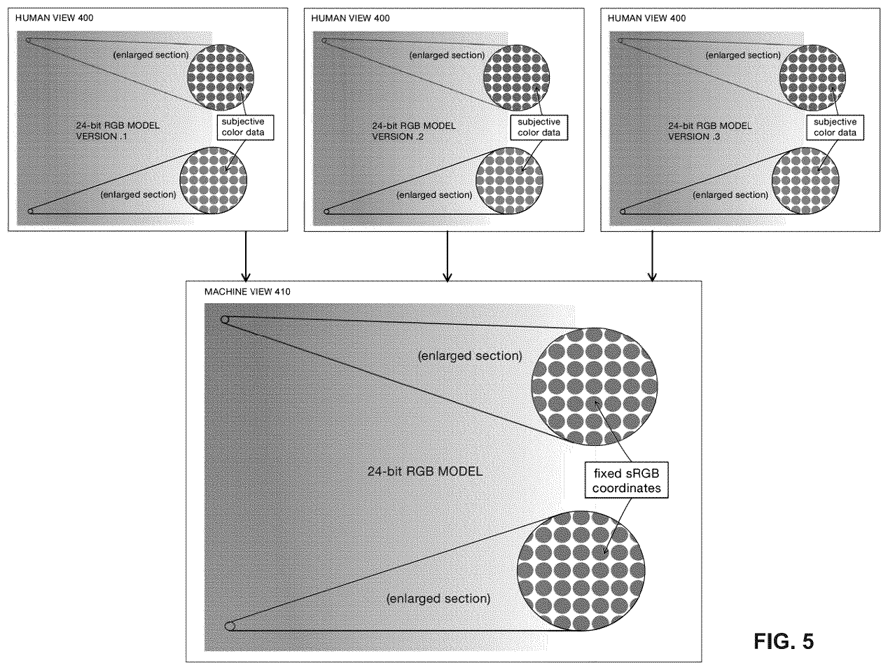

The sRGB color space consists of millions of redundant coordinates that are indistinguishable to the human eye. Variations on methods to assign color attributes for the RGB color cube adds to the problem of human visualization as there is no variation as to the number of fixed coordinates (16,777,216) or the mapping system. As exemplary shown in FIG. 5, the human eye cannot distinguish the difference in color (human view 400), but a machine cannot see it at all (machine view 410). As a data language model, it is akin to speaking gibberish. From a data standpoint, the conversion of a non-digital medium to sRGB is a random approximation. One hundred designers could use one hundred different sRGB coordinates to describe the same exact color. This makes it as random and subjective as using a word to describe a color. The sRGB coordinate system was intended to provide a means to display color palettes that pertain to design and coding content, as opposed to a precise analytics system. When used for its intended purpose, the redundancies in the language do not matter. These redundancies, however, make it impossible to index color data for machine learning and Artificial Intelligence. This requires a way to remove the redundancies from the sRGB color model without removing a single coordinate.

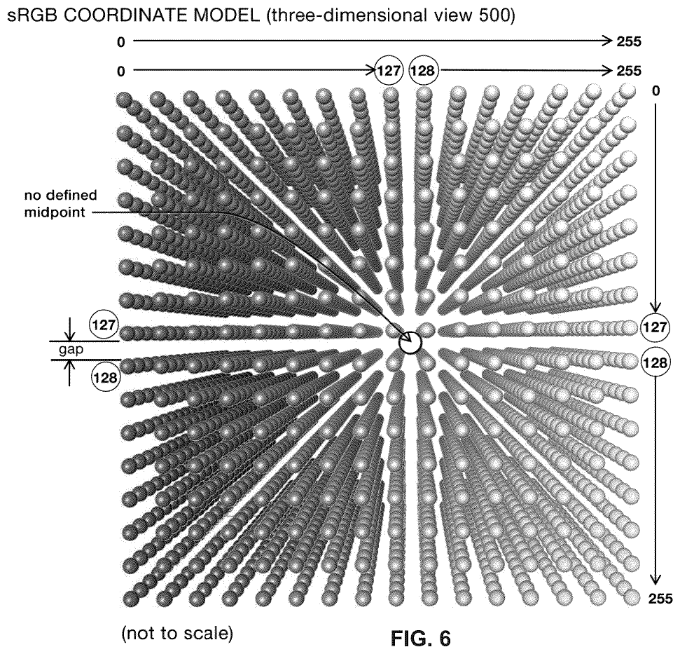

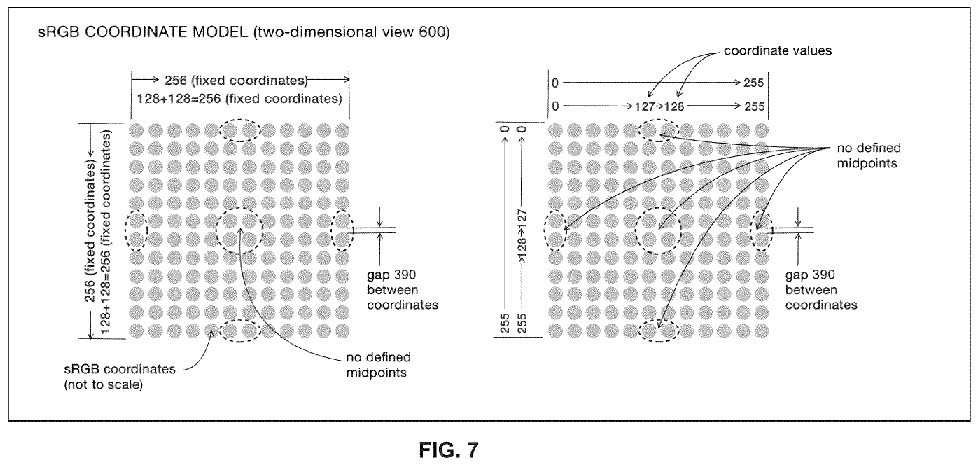

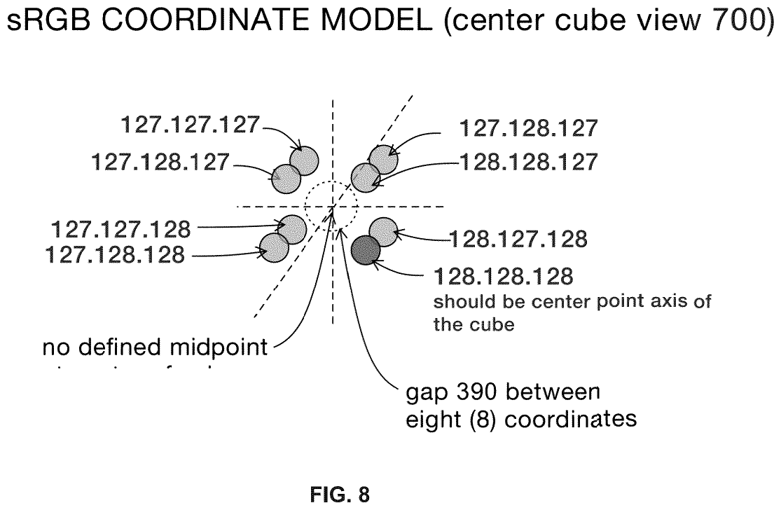

FIGS. 6-8 provide a color cube or a three-dimensional view 500, two-dimensional view 600 and center cube view 700 of the sRGB coordinate model, respectfully. There are natural spaces or “gaps” 390 between all of the fixed sRGB coordinates inside the color cube. The full length, from corner to corner, of the sRGB color cube 300 contains a total of 256 coordinates that are mapped from 0-255 per RGB channel. Half the distance of each side of the outer layer of the cube (x/2=y) is mapped from 0-127 and 128-255. It would seem logical to simply divide the length in half (256/2=128) to determine the midpoint. That, however, does not work based on the mapping of the coordinates. The coordinates mapped to values of 127 and 128 will reside on either side of the gap in the middle. In this sense, the appearance of a midpoint is an illusion. This occurs throughout the sRGB color cube 300. For example, drawing lines that connect the eight opposite corners (256/2=128) of the cube should intersect to create a center point axis. One coordinate (R: 128 G: 128 B: 128) should be located at the drop-dead center of the sRGB color cube 300. It does not, the mapping for the sRGB color cube 300, however, creates a gap 390 where the center of the sRGB color cube 300 should be located. In fact, it is only one of eight coordinates that surround the gap 390 in the center of the sRGB color cube 300. This lack of midpoints is consistent throughout the three-dimensional sRGB color cube 300.

Again, it is important to note that all of the sRGB coordinates that reside in the color cube are “fixed” in position and orientation, which is the means by which the color space can be mapped, and the coordinates located. As such, the lack of midpoints and a defined center point axis are not important in regard to the purpose for which it is designed. The sRGB color picker has no need for defined midpoints to locate and identify a coordinate color value. It was designed to be a “digital crayon” to apply color to websites and desktop publishing.

The redundancy that exists between the millions of coordinates, just like the lack of midpoints, is not important to the sRGB color model. The coordinates were not meant to be a color mapping language. The sRGB color model was not designed to index color data for machine learning and Artificial Intelligence. The claimed invention is predicated on the desirability of creating a new language model, specifically designed for data mapping and deep machine learning.

In accordance with an exemplary embodiment of the claimed invention, the claimed invention provides a method to collect and filter structure and unstructured product and user data using a Zencolor Nesting Cube and small language color model to generate artificial intelligence-based services.

Adding a coordinate to the sRGB color space to create a midpoint is not possible. That would produce more coordinates than the sRGB space actually contains.
RGB COLOR CUBE:
256 (0-255), corner to corner
256×256×256=16,777,216 coordinates
ADDITIONAL COORDINATE:
256+1=257 (0-256), corner to corner
257×257×257=16,974,593 coordinates

The “gap” 390 that naturally occurs between the coordinates cannot be eliminated. The fixed position of the coordinates makes it impossible to create midpoints in the sRGB color model 300. As discussed herein, the halfway point between 256 coordinates is 128 (256/2). Due to the gap 390 between the fixed position of the coordinates, however, it is mathematically impossible to create a midpoint. The midpoint lies within the gap between the two fixed coordinates:
0-127 (128 coordinates) 1 128 (1 coordinate) 1 129-255 (127 coordinates).

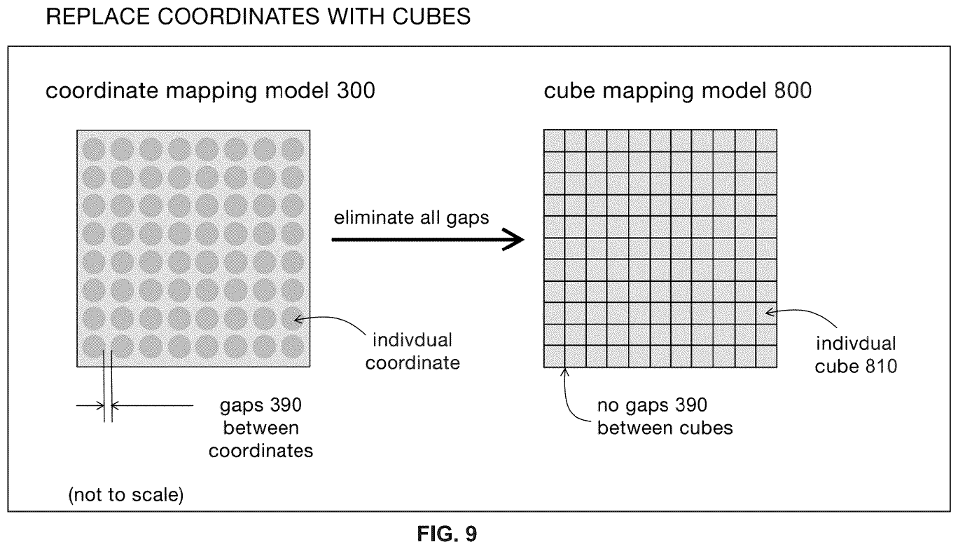

In accordance with an exemplary embodiment of the claimed invention, this problem is resolved by eliminating the gaps and creating midpoints. The claimed invention replaces the sRGB coordinate system 300 with a non-coordinate system or Zencolor Nesting Cube model 800, which eliminates the gaps in the sRGB color cube 300. In accordance with an embodiment of the claimed invention, as shown in FIG. 9, individually mapped cubes 810 are utilized, which are fixed in position like the coordinates. Each individual cube 810 represents a microcosm of the whole color cube 800, and when properly aligned, provides a means by which to merge the sRGB coordinates that reside in the same space within the new nesting cube model 800. Merging the two models removes the redundancies in the sRGB color model 300 without removing a single coordinate.

Unlike coordinates, and in accordance with an embodiment of the claimed invention, the individual cubes 810 abut one another and there are no gaps 390 between the cubes 810. This advantageously provides another part of the solution. By eliminating the gaps, the claimed invention can create true midpoints throughout the nesting cube model 800.

While colorists regard RGB as a means to display color on a device, they ignore that sRGB provides a unique opportunity to capture large steams of structured and unstructured color and product data. To exploit this opportunity, however, requires a new color language model. In accordance with an exemplary embodiment of the claimed invention, the new color language model merges the color coordinates into color cubes 810. This advantageously removes the redundancies in the 16,777,216 sRGB coordinates without removing a single coordinate. To enhance the usability of the new color language model, in accordance with an exemplary embodiment of the claimed invention, the nesting cube model provides a data mapping color language code that is intuitive and simple to learn.

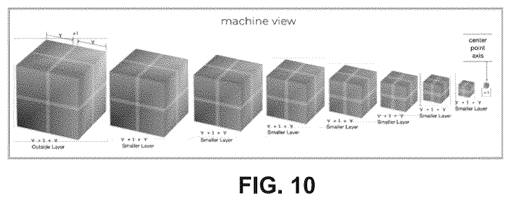

In accordance with an exemplary embodiment of the claimed invention, the Zencolor Nesting Cube data mapping model is based on a similar concept as a Russian nesting doll. The dolls are nested inside one another, decreasing in size until one reaches the last doll. As exemplary shown in FIG. 10, the six sides of the claimed Zencolor Nesting Cube model connect at every layer to form a cube within a cube. These cubes get progressively smaller and smaller until finally reaching the last cube, which is located at the center point (x-axis) of the Zencolor Nesting Cube structure.

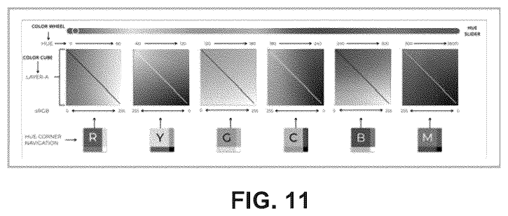

Analog color wheels display 360° of hue. Reconfiguring a circular color wheel produces a linear hue slider. In accordance with an exemplary embodiment of the claimed invention, as exemplary shown on FIG. 11, the gamut of the color wheel is mapped to the six outside hue corners of the sRGB color cube by reconfiguring the two-dimensional view of the outer layers of all six sides of the three-dimensional Zencolor Nesting Cube model.

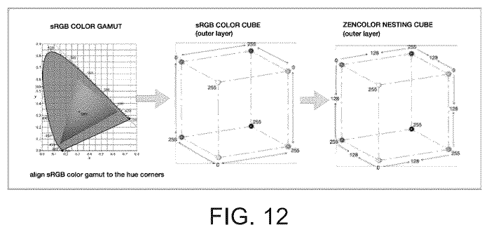

As exemplary shown in FIG. 12, the outside hue corners (Red, Yellow, Green, Cyan, Blue, Magenta) of the RGB cube and Zencolor Nesting Cube model are mapped to the same gamut. That provides symmetry between the two cubes, as well as a point of differentiation. The six sides that comprise the outer layer of the Zencolor Nesting Cube model, while the same as the sRGB cube, must be reconfigured in order to properly align the gamut.

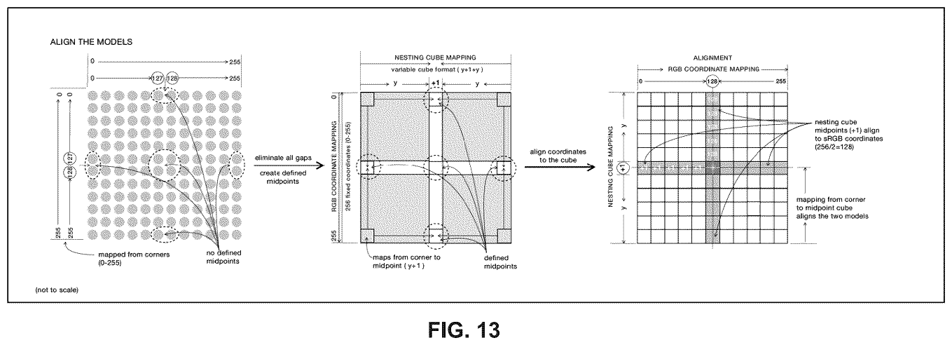

In accordance with an exemplary embodiment of the claimed invention, as shown in FIG. 13, the fixed positions of the sRGB color coordinates are aligned to the individual cubes 810 that make up the nesting cube model 800. The coordinates from sRGB cube are now properly aligned to create mathematically correct midpoints 910 throughout the claimed nesting cube structure 800. The creation of midpoints 910 in the claimed nesting cube model 800 provides a means by which to achieve this alignment. Whereas it is not possible to position the middle of the sRGB color cube 300 at the coordinate value of 128 (256/2), with the claimed invention, it is possible to align the cube in the middle of the nesting cube model format (y+1+y). The cube (+1) located in the center of the claimed nesting cube model 800 is a fixed position, regardless of the nesting cube format. The claimed invention provides a means by which to align the fixed sRGB coordinates to the fixed nesting cubes. In accordance with an exemplary embodiment of the claimed invention, the sRGB coordinate value of 128 is mapped to align with the exact center of the +1 cube. The other coordinates are mapped from the corners of nesting cube to the center midpoint of the +1 cube. This aligns the coordinates to the cube model, creating defined cube midpoints in the process.

CORNER→(+1)MIDPOINT←CORNER

For example, the sRGB coordinate (R: 128 G: 128 B: 128) that fell into the gap 390 between coordinates in the sRGB color space 300 now defines the precise center point of the individual cube 810. This is referred to as the “X-axis” 1000 in the new “nesting” cube model 800 in accordance with an exemplary embodiment of the claimed invention. Whereas this sRGB coordinate (R: 128 G: 128 B: 128) is not a center point in the sRGB color model 300, it is now at the drop-dead center of the new nesting cube model 800 of the claimed invention.

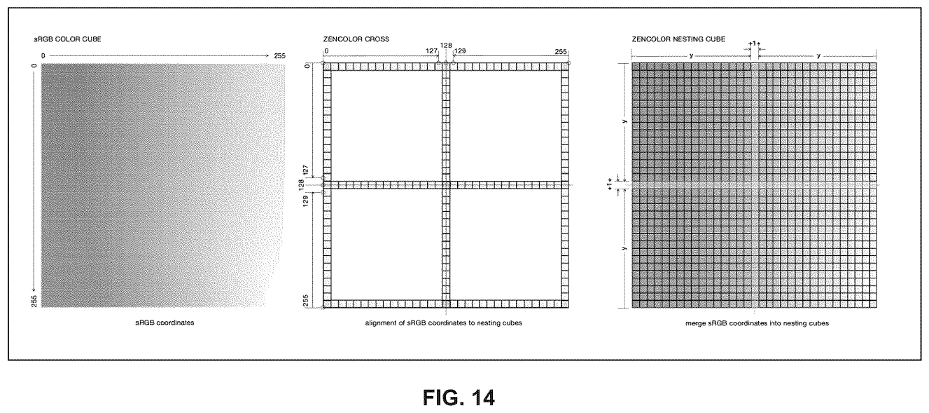

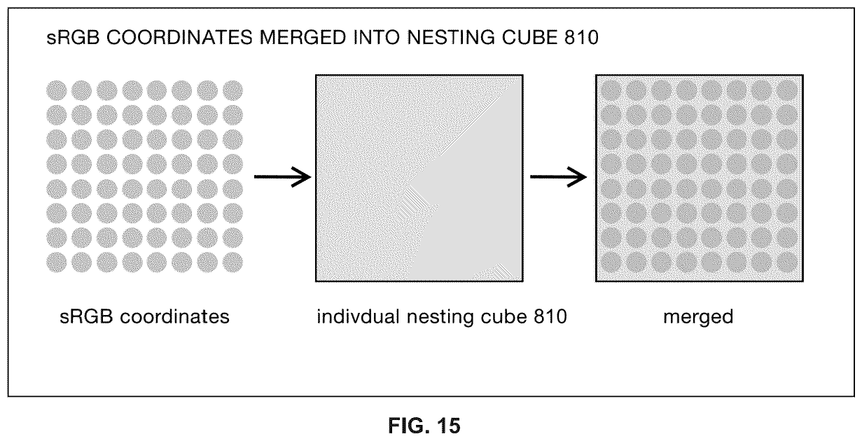

Once the two models are aligned, in accordance with an exemplary embodiment of the claimed invention, as shown in FIGS. 14-16, they are merged into a “bucket.” That is, the coordinates of the sRGB color cube are merged into the individual cubes 810 of the claimed nesting color cube 800, that already reside in the same fixed position, to provide a natural symmetry. This is possible because, while the two cubes are the same size, they are not mapped in the same way. The sRGB color cube 300 is mapped with coordinates, whereas the claimed nesting color cube model 800 is formatted by cubes 810 that are designed to hold the coordinates. In accordance with an exemplary embodiment of the claimed invention, the gaps 390 in the sRGB color cube 300 have been replaced with defined midpoints 910 in the claimed nesting color cube 800 (as noted herein, the zenColor Cross formation 900). Think of the two cubes as identical buildings that are impossible to tell apart when viewed from the outside. The 24-bit sRGB color cube or the sRGB color model 300 houses 16,777,216 coordinates that reside in fixed positions inside the cube-shaped building. The claimed nesting color cube model 800 contains cube-shaped apartments 810, the size of which is determined based on the format. When the two cubes are merged, in accordance with an exemplary embodiment of the claimed invention, the fixed coordinates (now aligned) are assigned to a cube 810 in the same fixed position and orientation. The midpoints 910 are now aligned to the individual cubes 810 in the claimed nesting color cube format 800. In the claimed invention, this alignment provides a means by which to “bucket” the sRGB coordinates into the individual cubes 810 without removing a single coordinate. All that remains is to assign “apartment numbers” by which to identify the cubes and apply a “paint job” that best represents the color attribute from the aligned sRGB residents.

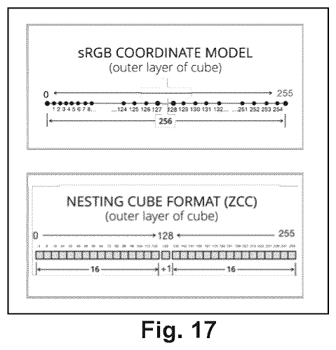

In accordance with an exemplary embodiment of the claimed invention, as shown in FIG. 17, aligning the color gamut of the two cubes makes it possible to map the coordinates from the outer layer of sRGB color cube (0-255) to the outer layer of the Zencolor Nesting Cube model (0>128, 128<255). Both cubes map to the same 8-bit channel, but the Zencolor Nesting Cube utilizes a different mapping format (y+1+y). For example, the ZENCOLOR® CODE (ZCC®) format is mapped to 16+1+16 which produces 35,937 individual nesting cubes in total. A smaller format, ZENCOLOR® ANALYTICS CODE (ZAC) is mapped to 8+1+8. These formats make it possible for a machine to objectively collect and filter the product and user data without the subjective (and often incorrect) interpretation of the human eye. ZENCOLOR® and ZCC® arc registered trademarks of the applicant (Zencolor Global, LLC).

In accordance with an exemplary embodiment of the claimed invention, as shown in FIG. 13, the fixed positions of the sRGB color coordinates are aligned to the individual cubes 810 that make up the nesting cube model 800. The coordinates from sRGB cube are now properly aligned to create mathematically correct midpoints 910 throughout the claimed nesting cube structure 800. The creation of midpoints 910 in the claimed nesting cube model 800 provides a means by which to achieve this alignment. Whereas it is not possible to position the middle of the sRGB color cube 300 at the coordinate value of 128 (256/2), with the claimed invention, it is possible to align the cube in the middle of the nesting cube model format (y+1+y). The cube (+1) located in the center of the claimed nesting cube model 800 is a fixed position, regardless of the nesting cube format. The claimed invention provides a means by which to align the fixed sRGB coordinates to the fixed nesting cubes. In accordance with an exemplary embodiment of the claimed invention, the sRGB coordinate value of 128 is mapped to align with the exact center of the +1 cube. The other coordinates are mapped from the corners of nesting cube to the center midpoint of the +1 cube. This aligns the coordinates to the cube model, creating defined cube midpoints in the process.

CORNER→(+1)MIDPOINT←CORNER

For example, the sRGB coordinate (R: 128 G: 128 B: 128) that fell into the gap 390 between coordinates in the sRGB color space 300 now defines the precise center point of the individual cube 810. This is referred to as the “X-axis” 1000 in the new “nesting” cube model 800 in accordance with an exemplary embodiment of the claimed invention. Whereas this sRGB coordinate (R: 128 G: 128 B: 128) is not a center point in the sRGB color model 300, it is now at the drop-dead center of the new nesting cube model 800 of the claimed invention.

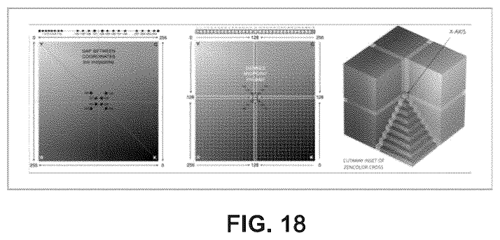

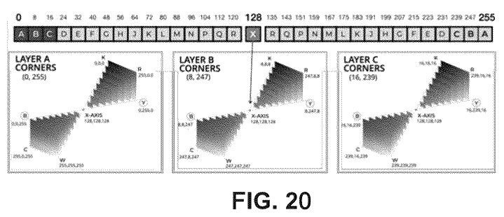

In accordance with an exemplary embodiment of the claimed invention, as shown in FIG. 18, mapping the sRGB coordinates to the Zencolor Nesting Cube format creates midpoints located at the coordinate denoted by red, green, and blue coordinate points numbered at “128” throughout the model. The gaps 390 between the coordinates in the sRGB model make it impossible to map these midpoints. Once mapped to the Zencolor Nesting Cube format, however, these midpoints become clearly defined. As shown in FIGS. 6 and 20, the coordinate system is replaced with individual cubes 810 that abut one another. Unlike the coordinates, in the claimed invention, there are no gaps 390 between the individual cubes 810. Whereas adding a coordinate (+1) to the sRGB color space 300 in order to create midpoints in the model is not possible, but creating such midpoints 910 through the use of an individually mapped cube format presents no problem.

All of the midpoints, including the center of the Zencolor Nesting Cube at the X-Axis are contained within the “zenColor Cross” formation. This formation, which consists of individual and equally sized cubes, has no gaps. The claimed invention applies a formula based on “y+1+y” as a format. This format creates midpoints 910 throughout the claimed cube-based model 800. In accordance with an exemplary embodiment of the claimed invention, these mapped midpoints 910 (+1) go from the outside of the three-dimensional cube 800 to the center of the cube (X-axis 1000) to form the zenColor Cross. The zenColor cross formation 900 of the claimed invention intersects at the middle of all six sides of the cube, extending from the outer layer to the center point or X-axis 1000. This center point or X-axis 1000 anchors the claimed nesting cube 800. The claimed zenColor cross formation 900 does not exist in the sRGB color cube model 300. The zenColor cross formation 900 feature is unique to the new nesting cube model 800 of the claimed invention.

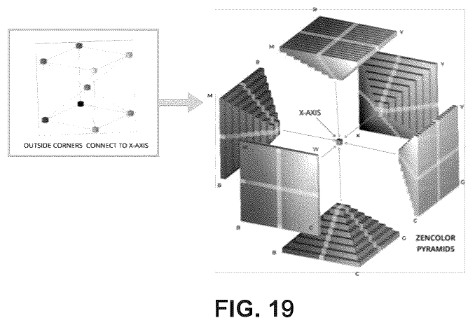

In accordance with an exemplary embodiment of the claimed invention, as shown in FIG. 19, the opposite corners on the outside layer of the Zencolor Nesting Cube connect through the center point located at the X-AXIS. Connecting the corners to the X-AXIS (R: 128 G: 128 B: 128) creates six “pyramid-like” structures. These structures are unique to the Zencolor Nesting Cube model.

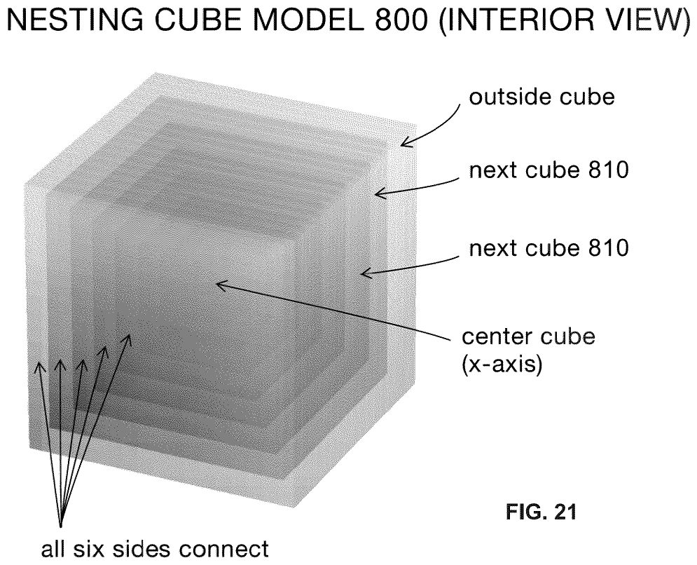

Turning now to FIGS. 10 and 21, the Cross formation (+1) or the zenColor Cross formation 900 (+1) is part of the format (y+1+y) that provides the midpoints 910 for the claimed nesting model 800, also known as the zenColor Nesting Cube model 800. In accordance with an exemplary embodiment of the claimed invention, all six (6) sides of the claimed “nesting” cube model 800 comprise a designation code for the hue (Red, Yellow, Green, Cyan, Blue, Magenta) that is positioned by the cube in the upper left-hand corner of the side. This remains constant from side to side and layer to layer. The black and white corners are considered grayscale and not a hue. The six sides of each layer connect to one another, layer by layer, to form a “nesting” cube 810. Much like a Russian nesting doll, the grid of each layer becomes progressively smaller, from the outside of the claimed nesting cube 800 until finally reaching the center of the cube 810 defined by the center point (X-axis) 1000. That is, the connected layers of the claimed nesting cube 800 approach the center, layer by layer. Peeling away the outer layers reveals that, while the cubes 810 in the claimed nesting cube format 800 remain the same size, the layers have less per side and become progressively smaller. In the claimed invention, the coded color cube that designates the shared center point (X-axis) 1000 is the last doll, so to speak. In accordance with an exemplary embodiment of the claimed invention, the individual color cubes are equidistantly mapped into grids, plotted by Longitude and Latitude, and represented by a six-digit code that represents the Cartesian mapping language.

The claimed nesting cube model, like the sRGB color cube 300, has eight defined corners. Unlike the sRGB color cube model 300, the claimed nesting cube model 800 is connected and anchored to a defined midpoint 910 called the X-Axis. Instead of eight equal quadrants, in accordance with an exemplary embodiment of the claimed invention, the nesting cube model 800 comprises six pyramid-like formations 1700 that share a common center.

In accordance with an exemplary embodiment of the claimed invention, as shown in FIG. 19, connecting the four (4) corners of any designated hue axis corner side to the center point (X-axis) of the claimed nesting cube model 800, creates a pyramid-like formation. There are six (6) of these pyramid formations in total. In accordance with an exemplary embodiment of the claimed invention, these pyramid formations can also be created by connecting the eight (8) opposite corners (R>X<C, G>X<M, B>X<Y, K>X<W) of the claimed nesting cube model 800 to the center cube x-axis (X). As there is now a defined center point (X-axis), in accordance with an exemplary embodiment of the claimed invention, the formula (y+1+y) now extends to all eight corners. In a sense, the X-axis acts like a ninth corner, anchoring the entire nesting cube structure. In accordance with an exemplary embodiment of the claimed invention, the six (6) pyramid formations are identical in size and contain exactly the same number of individual cubes 810. The pyramids “tier” as each identical layer moves progressively closer, layer by layer, to the X-axis located in the center of the nesting cube. In accordance with an exemplary embodiment of the claimed invention, this tiered pyramid structure, in tandem with the cross formation, provides a method by which to map the claimed nesting cube model 800. In accordance with an exemplary embodiment of the claimed invention, the grid of every side is mapped by longitude and latitude. The individual cubes 810 in the grid are equidistantly spaced, which advantageously produces a Cartesian mapping system. While the claimed zenColor Cross creates the claimed nesting cube model 800, the pyramid formation of the claimed invention provides a way to map the claimed nesting cube model 800.

In accordance with an exemplary embodiment of the claimed invention, as shown in FIG. 20, the layers that make up the pyramid formation are mapped from the outside corners to the center of the Zencolor Nesting Cube that is located at the X-AXIS. The exact number of layers depends on the Zencolor Nesting Cube format and the purpose for that format:
a. The content format (ZCC), which is based on a format of 16+1+16, which creates 16 layers to the X-AXIS and other mid points throughout the nesting cube model. It utilizes an eight bit channel, like the sRGB coordinate system, to create a smaller, more usable subset of RGB. Adding and subtracting +8/−8 from the sRGB coordinate system determines the size of the individual nesting cubes and the RGB value for the digital visualization of the cube for both the human eye and artificial intelligence. The smaller, and more efficient subset of RGB creates a small language model that has been named nRGB (Normalized Red Green Blue) by the applicant. This subset can be used in tandem with or to replace SRGB.
b. The data filtering format (ZAC) is based on a format of 8+1+8, which creates eight layers to the X-AXIS and other mid points throughout the Zencolor Nesting Cube model. It also utilizes an eight-bit channel, like the sRGB coordinate system, to create a smaller, more usable subset of RGB. Adding and subtracting +16/−16 from the sRGB coordinate system determines the size of the individual Zencolor Nesting Cubes and the RGB value for the digital visualization of the cube for both the human eye and artificial intelligence. The smaller, and more efficient subset of RGB creates a small language model that has been named fRGB (Filtered Red Green Blue) by the applicant. The ZAC data filtering system replaces generic color filters that use text tags such as Red, Yellow, Orange, Green, Blue, Pink, Blue, Purple, Black, White, Gray, Multi, etc.) to properly and programmatically “bucket” the color and other product related data, providing an objective means by which to sort and organize the data for machine learning and artificial intelligence.

In accordance with an exemplary embodiment of the claimed invention, as shown in FIG. 20, the numeric progression for both ZCC and ZAC formats, which are the best possible formats for defining the content and filtering the data, make it possible to map the Zencolor Nesting Cube format and identify the color attributes for the individual cubes.

In accordance with an exemplary embodiment of the claimed invention, as shown in FIG. 20, the sides and layers of the pyramid formation within the Zencolor Nesting Cube model create a grid of individual cubes that are mappable to RGB coordinates. The RGB coordinate value for both nRGB and fRGB provides a unique color attribute for each individual cube in the ZCC and ZAC nesting cube formats. There is a one-to-one relationship between nRGB and the corresponding ZCC nesting cubes (36,970) and between fRGB and the corresponding ZAC nesting cubes (4,913). This symmetry advantageously provides a means to programmatically and objectively collect, sort, and filter the data.

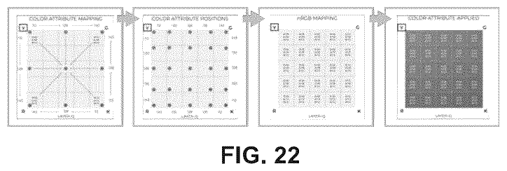

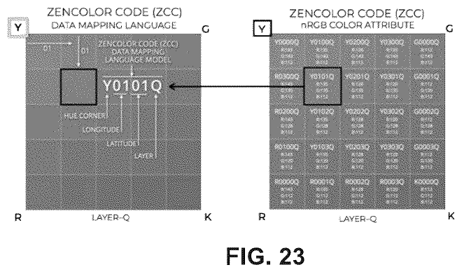

In accordance with an exemplary embodiment of the claimed invention, as shown in FIGS. 22 and 23, each of the individual cubes in the Zencolor Nesting Cube model, regardless of the format, provides the basis for a three-dimensional Cartesian mapping system. The six hue corners (Red, Yellow, Green, Cyan, Blue, Magenta) represent the six sides of the cube, represented by a one-digit identification (R, Y, G, C, B, M). Each successive layer is represented by another one-digit value which depends on the Zencolor Nesting Cube format. In accordance with an exemplary embodiment of the claimed invention, the ZCC Nesting Cube format layers are mapped to sixteen layers (A, B, C, D, E, F, G, H, J, K, L, M, N, P, Q, R). In accordance with an exemplary embodiment of the claimed invention, the ZAC nesting cube format layers are mapped to sixteen layers (A, B, C, D, E, F, G, H). Both formats have the same center point located at R: 128 G: 128 B: 128, which is denoted by Layer X. All sides and layer of the formats are divided into grids mapped by Longitude and Latitude. This is mapped from the hue corner of every layer, providing orientation for both humans and machines.

Turning now to FIGS. 11, 20, 23 and 24, in accordance with an exemplary embodiment of the claimed invention, the data mapping color language model is represented by a six-digit code. In accordance with an exemplary embodiment of the claimed invention, the six-digit code or the color code 2000 consists of the hue axis corner, as exemplary shown in FIG. 23, a grid displayed in longitude, latitude, and a layer. One example of the color code for data mapping color language mode is zenColor Code (ZCC) 2000. The color code is a perfectly balanced and equidistant Cartesian mapping system. In accordance with an exemplary embodiment of the claimed invention, the longitude and latitude are mapped to each of the six sides of the nesting cube, the grid decreasing layer by layer to the center (x-axis). The order of the mapping code can be changed to denote different model formats, but the basic components that represent the code remain the same:
HUE SIDE AXIS: one digit (R, Y, G, C, B, M)
LONGITUDE: two digits (00)
LATITUDE: two digits (00)
LAYER: one digit (A, B, C, D, E, F, G, H, J, K, L, M, N, P, Q, R, X)
INDIVIDUAL CUBE CODE: 6 digits

For the purpose of identification, in accordance with an exemplary embodiment of the claimed invention, each individual cube 810 in the nesting cube format 800 requires an assigned mapping code. The color codes 2000 serve that purpose. In accordance with an exemplary embodiment of the claimed invention, the data mapping language provides an identifiable code 2000, along with the orientation of that code. While a machine cannot “see” color, it can understand orientation which is what the data mapping language model provides. Accordingly, the claimed invention advantageously enables a machine to measure and understand the position of any individual cube within the overall nesting cube format. As such, the color codes 2000 advantageously provide a means to map the nesting cube without color attributes.

The Hue Corners (Red, Yellow, Green, Cyan, Blue, and Magenta) define the sides of the cube. This provides a starting point by which to map each layer of the cube, as well as the orientation that is needed to teach the claimed mapping language to a machine.

As exemplary shown in FIG. 20, the layers of the nesting cube 800 converge at the center point (X-Axis). The longitude and latitude are mapped to each of the six sides of the nesting cube, the grid decreasing layer by layer to the center (X-axis).

In accordance with an exemplary embodiment of the claimed invention, the nRGB and fRGB color attributes for both the ZCC and ZAC Nesting Cube formats respectively, align the data visualization of the individual Nesting Cubes in the format for both the human eye and a machine.

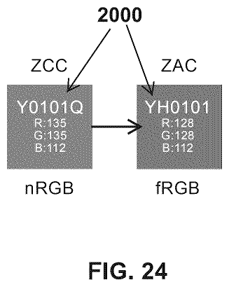

In accordance with an exemplary embodiment of the claimed invention, as shown in FIG. 24, the “symmetry” of the color data mapping language models (ZCC and ZAC) enables a machine to programmatically collect and filter the color data, along with all of the “sticky” user and product data that adheres to the digital color swatch that represents the product image.

It should be noted that both the product and user data is contextual. The user's name, age, gender, geolocation and other data that pertains to the user will be no different when digitized than it is if written on a piece of paper. The same can be said for product data. The product description, product number, color name, color number, size, material, and other data that pertains to the product itself remains constant in both physical and digital format. Visualizing the color, however, requires a translation from a physical product to the digital representation of the product on a device. This translation to a universal digital color system based on the Zencolor Nesting Cube model creates a “common denominator” by which to objectively and programmatically “bucket” the user and product data, along with the user's personal preferences, enabling machine learning and artificial intelligence to generate hyper-personalized search, data analytics, data marketing, and other consumer services that mimic a personal shopper.

There are thousands of non-digital color specification systems, none of them alike. All of these systems must be converted to digital RGB in order to display color content on a device. While all of the attributes of the product data (color description, style number, size, etc.) and user data (name, gender, geolocation, etc.) remain contextual after being converted from a print to digital format, nevertheless the visualization of the color must be translated to RGB in order to display the color on a digital device. This provides the opportunity to create a “common denominator” with the color component to properly sort and structure the product and user data. But how is this possible? Machines, unlike humans, cannot “see” color. Artificial Intelligence currently relies on subjective and random human interaction with the color translation from a physical product to the images that represent the product to properly sort and structure the color data. While a machine may be able to visualize the difference between 16,777,216 sRGB coordinates, is far too redundant and indiscernible for the human eye. Addressing this issue requires a smaller, more efficient subset of RGB that can align the color between a physical product and the digital image that represents the product online, as well as aligning the data between a human being and a machine. The Zencolor Nesting Cube and small language models were designed to specifically achieve this goal.

Replacing random sRGB values, subjective color descriptions, and generic text tag color filters to sort and filter the structured and unstructured product and user data with the Zencolor Nesting Cube and small language model is transformative to retail systems. In accordance with an exemplary embodiment of the claimed invention, the claimed invention makes it possible for machine learning and artificial intelligence to objectively and programmatically collect and filter this data to provide hyper-personalized shopping services that benefit consumers and retailers alike.

This process requires two critical steps:
a. Align the color data between physical product and digital images that represent the product online.
b. Align the color data visualization for humans and machines.

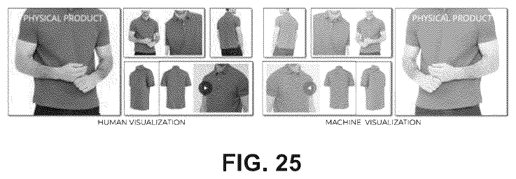

The alignment of color data between a physical product and the digital image(s) that represents that product online is critical for both consumers and retailers alike. There is currently no system available to resolve the issue of matching the color of the product to the color of the image. Several factors involving adjacency, luminosity, and monitor calibration make color matching nearly impossible to achieve. More importantly, is the subjectivity of the human eye. As no two people see or describe color the same way, even if all the other factors could be corrected, it is not possible for the human eye to match the color of the physical product to the images, including the swatch, that represent the product online. This problem leads to at least $40 B a year in costly returns, restocking, and shipping charges-and that's just in North America. This lack of data alignment not only presents a problem for retailers and online shoppers, but it also provides a significant challenge to artificial intelligence. The Zencolor Nesting Cube and small language model provide a solution to these costly problems. As exemplary shown in FIG. 25, machines, unlike humans, cannot “see” color. As such, color matching for a machine is not contingent on luminosity, adjacency, or monitor calibration. A machine can sample the image, extract the sRGB data, and run a programmatic comparison between the sRGB and nRGB coordinates to provide a Delta E measurement. This provides a quality assurance system to ensure that the image colors are correct, much like the systems that are already in place to manufacture the physical product. While this method is not perfect, it is far better than current methods that are completely dependent on the human eye and other factors. Another advantage of the converting the physical color of the product to a smaller, more efficient subset of RGB is that it is now possible to programmatically and objectively filter the color data, along with the other “sticky” user and product data. In addition, in accordance with an exemplary embodiment of the claimed invention, the Zencolor Nesting Cube and small language models can “homogenize” all of the diverse color descriptions on the platform, vendor to vendor, and platform to platform, into a single-color language that is universally understood. This process is critical. It enables machines learning and artificial intelligence to generate hyper-personalized shopping and other services that are of great benefit to retailers and shoppers alike.

Aligning the physical and digital color assets requires a universal color data standard. In accordance with an exemplary embodiment of the claimed invention, the small language model advantageously aligns the product and product image data by standardizing color visualization for both humans and machines.

A color name is assigned to help identify and market a product at design inception. The process is completely subjective as any number of different names can be used to describe the exactly the same color. For example, the color name “Mahogony Red” is meaningless to both a human being or a machine without definition, translation or, more importantly, data visualization. All human beings see and describe color differently. For a human being to understand the color that “Mahogony Red” represents they must be able to visualize either a physical sample or a digital representation of the color. A machine, on the other hand, cannot “see’ color at all. In order to visualize the color, the machine needs a digital RGB coordinate. In accordance with an exemplary embodiment of the claimed invention, aligning the data visualization of “Mahogony Red” to both a machine and a human being requires a universal color data standard that the Zencolor Nesting Cube and small language model provides.

A retailer with thousands of vendors must contend with thousands of different ways to describe a color, none of them the same. This creates “color chaos” across the eCommerce platform, particularly when it comes to searching for a product color. There is great potential for artificial intelligence to generate retail shopping and other services, but it requires being able to harness the user and product data generated by online search. At the moment, product search powered by artificial intelligence will be no more successful than current search technology. Given the tools that the Zencolor Nesting Cube and small language models provide, however, this problem can easily be resolved.

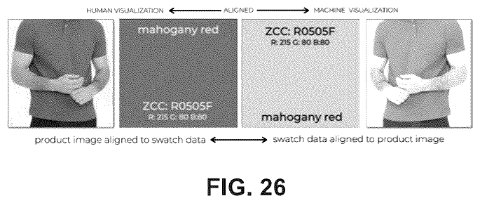

The digital color swatch that represents the product image color is currently created by randomly extracting an sRGB coordinate from the raw RGB that comprises the product image. This process, manually performed by a human being, is random and subjective. This often leads to misrepresentation of the swatch color versus the product image color versus the color of the actual product. In effect, the color data is incorrect. The smaller, more efficient language model eliminates the need for a human being to manually extract the sRGB data from the product image, which is often incorrect. This can be corrected by setting up a quality assurance system during the production process that properly evaluates the digital conversion of the color of the physical product to a digital color standard by which to match the image. In accordance with an exemplary embodiment of the claimed invention, the Zencolor Nesting Cube and small language model provide a smaller, more efficient subset of RGB that provides this digital swatch standard. As exemplary shown in FIG. 26, the standardized swatch standards align the data between the physical product and the images that represent the product (including the swatch) which, in turn, helps to align color data visualization between a human and a machine. This is critical to online shoppers and the machine generated hyper-personalized shopping services for search, data analytics, and data marketing, and other features.

In accordance with an exemplary embodiment of the claimed invention, the ZENCOLOR ANALYTICS CODE (ZAC) is specifically designed to properly filter the color data, along with all of the other “sticky” user and product data that adheres to the ZCC data swatch. The 4,913 individual Zencolor Nesting Cubes are far more representative and color specific than current 24-36 generic color filters (text tags). Again, the Zencolor Nesting Cube filter generates its own small language model that enables data visualization for both humans and machines.

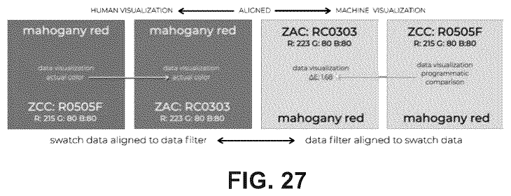

The ZAC data filter also has another important purpose. A retailer with ten thousand vendors currently contends with at least ten thousand color descriptions for products, none of them the same. In accordance with an exemplary embodiment of the claimed invention, once applied as shown in FIG. 27, the ZAC small language model will “normalize” all of the diverse color descriptions into a single data standard across all vendors on the eCommerce platform, platform to platform. The integration of the Zencolor Nesting Cube and small language models will make it possible for machine learning and artificial intelligence to perform hyper-personalized “smart searches” for online shoppers across any and all eCommerce platforms. In effect, this provides the potential for “social” shopping networks that interconnect retailers and online shoppers around the world.

Online search is critical to understanding consumer preference for color and other product-related data. Currently, product color search is generated by extracting the sRGB color coordinate (16.77M) from the raw RGB value of the image and then “bucketing” the product data into a “color filter” that is based on 24-36 generic text tags. This makes searching for a product color cumbersome, if not impossible, especially when it comes to searching for patterns that can represent up to twenty percent of all product inventory. All patterns, regardless of color, are bucketed into text tags called Multi, Pattern, or other terms that describe generic patterns. As difficult as it is to search for a product, it makes it almost impossible to understand the color data. For example, if the color data is placed in a generic bucket for the RED color family, it covers thousands of subjective color descriptions and two to three million sRGB coordinates, most of which are not discernable to the human eye. In effect, bucketing the data into these generic color filters destroys the ability to hyper-personalize the color data, as well as the product and user “sticky” data that adheres to the color swatch. There are too many variables, and the data is too random and subjective to be properly collected or filtered. As color is 85% of the reason behind all consumer product purchases, it is impossible to ignore the value of color as a key and critical data set.

In accordance with an exemplary embodiment of the claimed invention, the Zencolor Nesting Cube and small language models resolve the current issues with all online product search. While the images still consist of raw RGB, the 16.77M sRGB coordinates are replaced by the smaller, more efficient nRGB small language model that consists of 35,970 coordinates. In accordance with an exemplary embodiment of the claimed invention, the nRGB color swatch represents and better aligns the color of the physical product to the corresponding product image, while simultaneously aligning the color data visualization between the human eye and a machine.

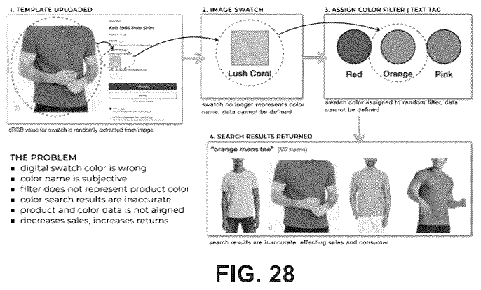

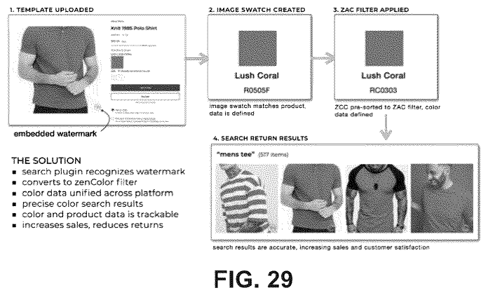

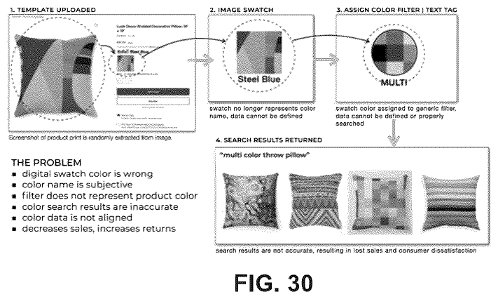

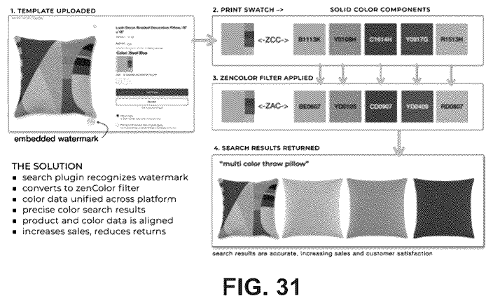

Further, the Zencolor Nesting Cube and smaller color language models apply better to both solid colors and print patterns. This application makes it easier for online consumers to search for a precise solid color or a key color within a pattern as opposed to a generic color family. In accordance with an exemplary embodiment of the claimed invention, as shown in FIGS. 28-31, this alignment between the color data swatch and color data filter that the Zencolor Nesting Cube and small language model programmatically and objectively makes it easier to sort and filter the color data. All of the other contextual “sticky” product data (style number, material, size, color name, etc.) now can adhere to the ZCC Nesting Cube that corresponds to the nRGB color coordinate attribute. In turn, in accordance with an exemplary embodiment of the claimed invention, this data can be properly filtered into a yet smaller subset within a ZAC data filter. This filter provides a “common denominator” to sort and filter all product and user related data, as well as providing a tool to “homogenize” the color descriptions across any given eCommerce platform that integrates the model. Adoption of the Zencolor Nesting Cube and small language models provides the necessary tools to enable machine learning and artificial intelligence to generate hyper-personalized “smart search” and other useful services.

Hyper-personalized shopping services generated by machine learning and artificial intelligence are dependent on consumer interaction with product assortments to determine consumer preference. The interaction that occurs between an individual consumer and a product during an online search for a retail product is key to understanding personal preference. In accordance with an exemplary embodiment of the claimed invention, the integration of the Zencolor Nesting Cube and small language models is critical to achieving this goal.

The current dataflow from the Product Lifecycle Management (PLM) system to the eCommerce platform, particularly when it comes to the color, lacks the means for machine learning and artificial intelligence to properly generate hyper-personalized services. While the collection of the user and product data is currently possible, there is no means available by which to filter and structure the data in order to properly define personal preference. This can be attributed to a couple of factors. Firstly, the manual extraction of the digital color swatch from the product image is a random, subjective, and unreliable process. Additionally, the product images and swatch may or may not represent the color of the actual physical product. Therefore, the other “sticky” product data adheres to a mispresented color. Secondly, sorting the digital color swatch manually into a generic color filter, using nothing more than the naked human eye, is even more random, subjective, and unreliable. The text tags are too broad and generic to properly filter and structure the data. As such, any attempt to properly personalize the data using artificial intelligence is doomed to fail, for much the same reasons that current product color searches currently fail today.

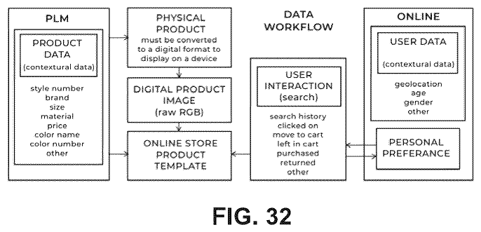

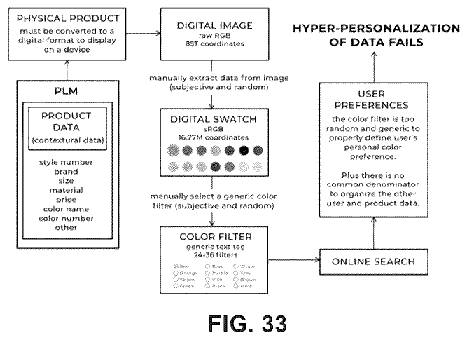

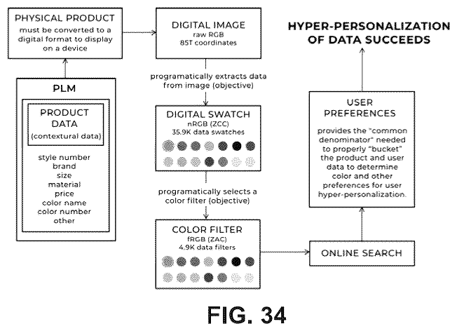

In accordance with an exemplary embodiment of the claimed invention, the Zencolor Nesting Cube and small language models resolve this issue across the product ecosystem. The ZCC data swatch utilizes a smaller, more efficient color language model for data visualization, reducing the number of coordinates from 16,777,216 (sRGB) to 35,970 (nRGB). As shown in FIGS. 32-34, this is achieved by mathematically removing the redundancies contained within the sRGB color model that are imperceivable to the human eye. This smaller, more efficient color language model provides an objective and reliable method collect and organize the other “sticky product data that adheres to the individual ZCC cube. In accordance with an exemplary embodiment of the claimed invention, as shown in FIGS. 32-34, this data can be programmatically and objectively moved from the ZCC Nesting Cube model into the corresponding ZAC Nesting Cube filter, which consists of 4,913 individual cubes. All of the ZCC Nesting Cubes have been mathematically preassigned to these corresponding ZAC filters, which eliminates the need for manual sorting and guesswork. In accordance with an exemplary embodiment of the claimed invention, this manual and tedious task can now be performed objectively by a machine. As opposed to current generic color filters or text tags, the ZAC filters provide a usable “common denominator” by which to properly sort and structure both the color and user data, along with the user's personal preferences that are collected from online search. This enables machine learning and artificial intelligence to generate hyper-personalized suggestions for search, data analytics, data marketing and concierge shopping services. Further, the small language model provides a faster and more efficient means of computing the data.

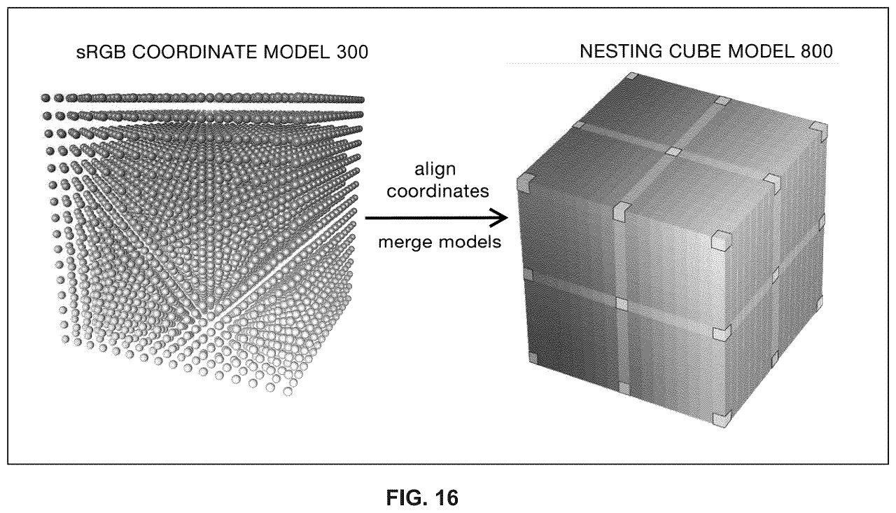

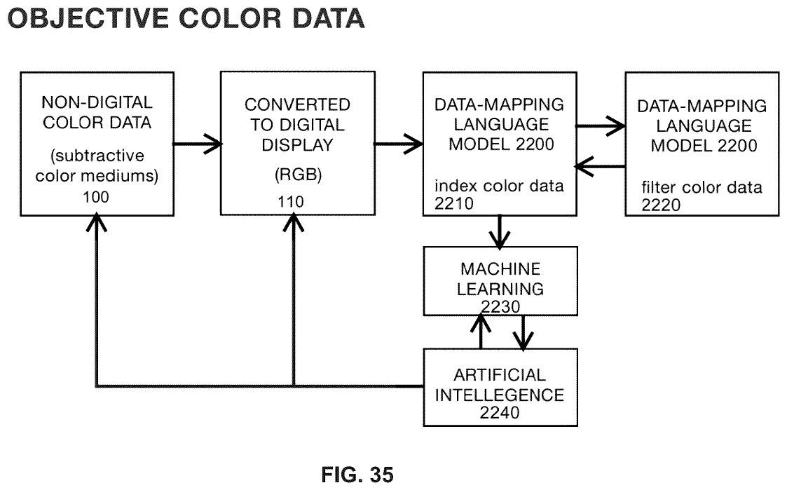

The data points ingested by machine learning and artificial intelligence (ML-AI) engine 2804 (FIG. 35) are critical to Artificial Intelligence. While a machine may not need to “see” a color, a human being does. For color data to be analyzed by Artificial Intelligence and then fed back to a human, a color attribute will need to be applied. This holds true for any interaction with a human being for any usage of the nesting cube color language model. The sRGB color space is not designed for this purpose. In accordance with an exemplary embodiment of the claimed invention, as shown in FIGS. 16, 17 and 23, the alignment and merger of the two models advantageously provides a method to programmatically assign a color attribute to each individual cube. Adding the color attribute to the nesting cube format in either two- or three-dimensional format, provides a means by which the human eye can visualize the data. The claimed nesting color cube allows data visualization with the human eye, which enables a colorized nesting cube model 800 to be advantageously displayed on a digital substrate, i.e., digital device. The mapping is the same on every side and layer through the claimed nesting cube model 800.

Identifying a precise hue that is represented by a color cube code 2000, such as the zenColor Code (ZCC), is not dependent on the human eye. The color cube code or the color code 2000 of the claimed invention does not rely on subjective words like “red” or “tequila sunrise” to describe a color. The claimed numeric color code 2000 is completely objective. Nor does it depend on a coordinate system that contains so much visual redundancy that it is impossible to differentiate one coordinate from another. Instead, in accordance with an exemplary embodiment of the claimed invention, these sRGB coordinates are merged into the nesting cube model 800 and identified with the claimed universal color data mapping language. Without the claimed universal language model, it would be impossible to collect and index color data by the machine learning and Artificial Intelligence engine 2804.

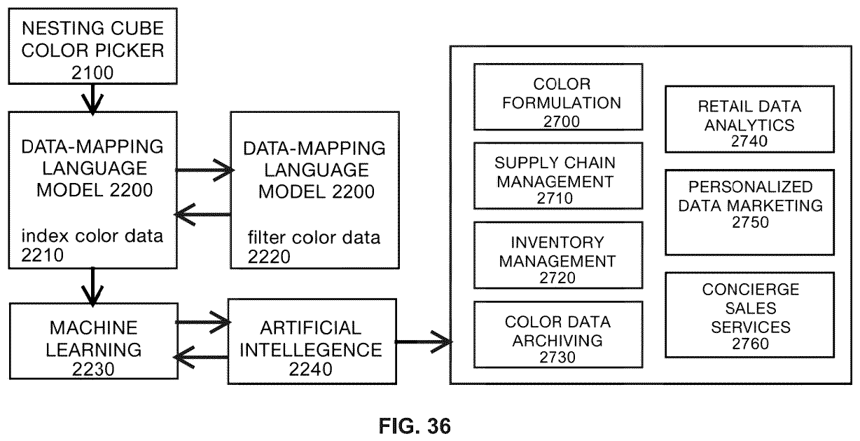

Turning now to FIGS. 35 and 36, the universal color data mapping language model is neither additive nor subtractive. In accordance with an exemplary embodiment of the claimed invention, the universal color data mapping language model 2200 is universal and can be applied to both digital and non-digital substrates (steps 100, 110). As such, the claimed universal color data mapping model 2200 is unique and useful. The claimed universal color language model 2200 provides retailers and manufacturers with a tool to identify, filter and index all other digital and non-digital color information at any point in the lifecycle of any product with a standardized color attribute (steps 2210, 2200). In accordance with an exemplary embodiment of the claimed invention, the claimed universal color language model 2200 collects, filters and indexes both digital and non-digital color data (steps 2210, 2220), both historic and trending, for deep machine learning (step 2230). These color data points can be ingested and interpreted further by Artificial Intelligence for a multitude of useful purposes (step 2240). It is appreciated that the claimed universal data mapping color language model 2200 can be applied to a wide variety of useful applications across all aspects of the product ecosystem that benefits both retailers, wholesalers, distributors, manufacturers and consumers. That is, the claimed color language model 2200 will benefit retailers and manufacturers in all areas of product development, eCommerce search, color formulation 2700, supply chain management 2710, inventory management 2720, color data archiving 2730, data analytics 2740, personalized data marketing 2750, and data visualization to provide concierge sales services 2760 to all consumers powered by machine learning and Artificial Intelligence engine.

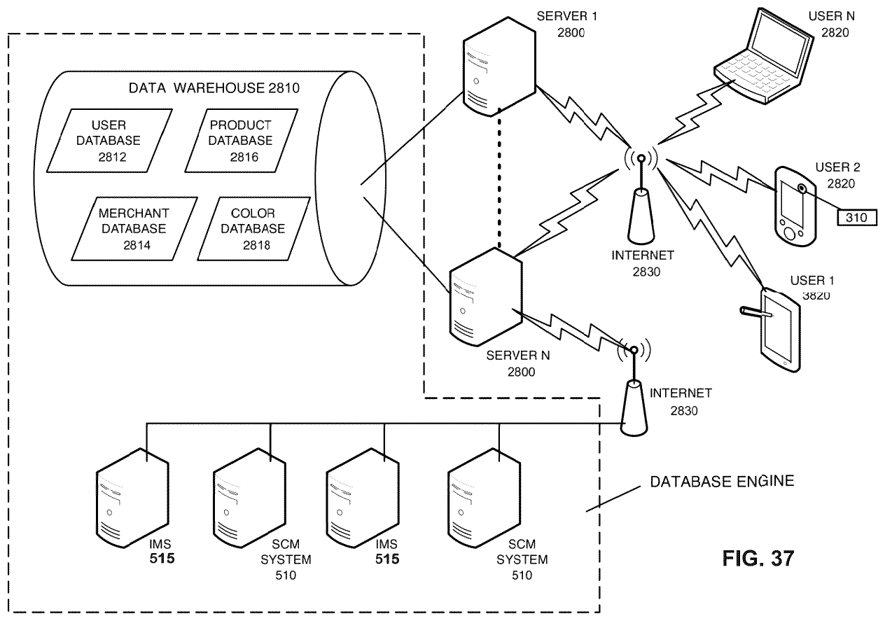

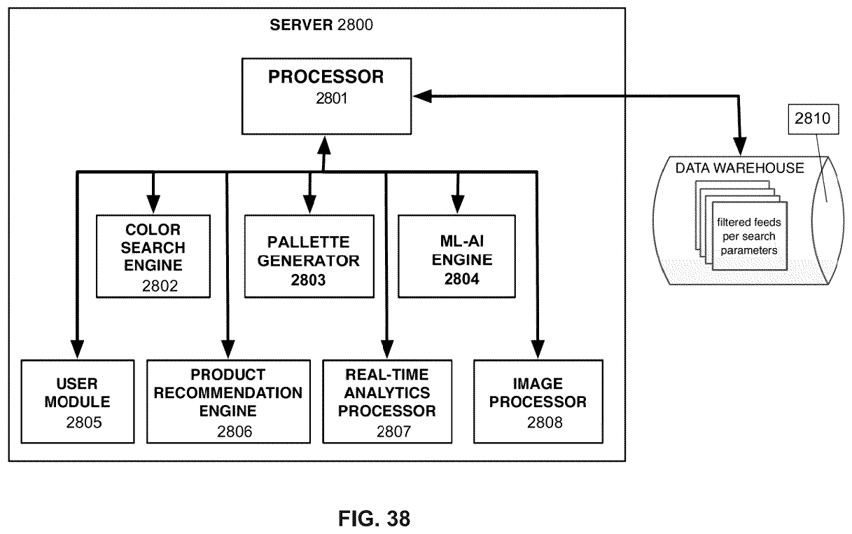

Turning to FIG. 37, in accordance with an exemplary embodiment of the claimed invention, there is shown an exemplary system configuration comprising a processor-based system, such as one or more processor-based computers or processor-based servers 2800, with the hard disk or memory drives running software comprising machine-readable program instructions. Server 2800 serves as and/or provides access to the data warehouse 2810, which comprises the product database 2816 and the color database 2818. Preferably, data warehouse 2810 also comprises user database 2812 and the merchant database 2814. All data are maintained in the data warehouse 2810 or other conventional database system having read and write accessibility using a database management system. Although described herein for illustrative purposes as being separate data stores, in at least some alternative embodiments, the data stores may be combined in various combinations.

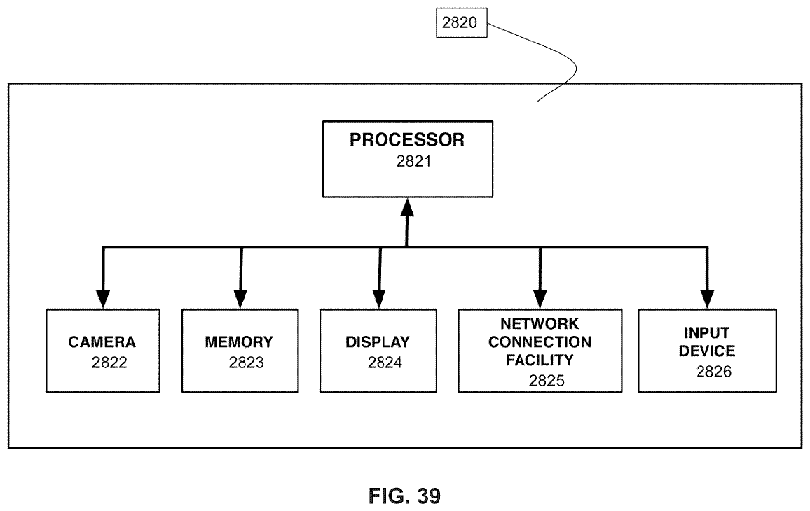

Information contained in the data warehouse 2810 is accessible by both consumer and Merchant users via the client devices 2820 over a communications network 2830, such as the Internet 2830. Client devices 2820 comprise processor-based machine(s), such as laptops, PCs, tablets, smart phones and/or other web-enabled handheld devices to and from which the server 2800 communicates. In accordance with an exemplary embodiment of the claimed invention, as exemplary shown in FIG. 39, the client device 2820 comprises a processor 2821, an optional camera 2822, a memory 2823, a display 2824, a network connection facility 2825 and an input device 2826. The client devices 2820 are connected to the server 2800 utilizing customizable interfaces described herein. The custom interfaces may be in the form of a graphical user interface, an application to form a client-server arrangement and/or other well-known interface conventions known in the art. Depending on the nature of the user and its access to various forms of information, different interfaces are made available. To support various options, the system of the present invention preferably includes at least one application-programming interface (API) so that certain types of users could enhance their interfaces, and different ones may be available for users and Merchants.

In accordance with an exemplary embodiment of the claimed invention, the subscribers (consumer or Merchant users, etc.) gain entry to the server 2800 by subscription using known security methodologies, e.g., username and password combination. Once a subscriber is authenticated, the server 2800 provides access to the data that the subscriber can rightfully access.

As more fully described in applicant's normalization/codification application, the server 2800 receives product information (i.e., feeds) over the communications network 2830 from a plurality of Merchants. The server 2800 receives the feeds from retailers', wholesalers', and/or manufacturers' inventory management systems (“IMS”) 515 or supply chain management (“SCM”) systems 510. It is appreciated that for simplicity merchants, retailers, wholesalers and manufacturers will be collectively and interchangeably referred to herein as Merchants. Preferably, as new products are added or product information is updated in the IMS 515 and/or the SCM system 510, the corresponding information is transmitted to the server 2800. That is, the IMS 515 and/or SCM system 510 dynamically transmit the updated information to the server 2800.

SCM is the management of the flow of goods. It includes the movement and storage of raw materials, work-in-process inventory from inception to finished goods. SCM is defined as the design, planning, execution, control, and monitoring of supply chain activities with the objective of taking a product from inception (design) to a finished product. A product runs through the SCM system 510 and, when finished, transfers into the IMS 500 which tracks the finished goods.

The SCM system 510 is a production based system used by factories and their component suppliers. Within the SCM system 510 there may be an element of the IMS 500, which would be used to keep track of the inventory of components and raw materials. That said, the SCM system 510 is strictly a B2B (business-to-business) system that does not involve the consumer unless it is utilized for the use of “previewing” future inventory to a consumer in order to gauge future sales and make adjustments during the manufacturing process.

Whereas, the IMS 515 is a computer-based system for tracking inventory levels, orders, sales and deliveries. It can also be used in the manufacturing industry to create a work order, bill of materials and other production-related documents. Companies use the IMS 515 to avoid product overstock and outages. It is a tool for organizing inventory data that before was generally stored in hard-copy form or in spreadsheets.

Modern IMS 515 often rely upon barcodes and radio-frequency identification (RFID) tags to provide automatic identification of inventory objects. Inventory objects can include any kind of physical asset: merchandise, consumables, fixed assets, circulating tools, library books, or capital equipment. To record an inventory transaction, the IMS 515 uses a barcode scanner or RFID reader to automatically identify the inventory object, and then collects additional information from the operators via fixed terminals (workstations), or mobile computers.

The new trend in inventory management is to label inventory and assets with quick response (QR) Code, and use smartphones to keep track of inventory count and movement. These new IMS 515 are especially useful for field service operations, where an employee needs to record inventory transaction or look up inventory stock in the field, away from the computers and hand-held scanners.

The barcodes, RFID tags and QR codes are normally implemented during the production process as part of the Specification Sheet (Spec Sheet) which conveys all of the product details such as Color Code, Style Code, Vendor Code, and the information (fabric content, size, product category) that may be contained within any or all of these codes. The SCM system 510 stores the Spec Sheet. The barcodes, RFID tags and QR codes are also used as a tool to track inventory sales in the IMS 515 which is done by scanning at point of sale.

Without the universal digital data-mapping color language model of the claimed invention, color data from these various barcodes and tags cannot be identified or defined. If the color name is “sterling blue” and the actual color is a shade of blue grey, a search for the color will produce the tagged names unless the system is performing an image analysis for the precise color and ignoring the information provided by barcodes and tags. Once the color is normalized, codified and categorized into a single universal digital system of the claimed invention, the same search now can be performed more effectively by search based on color in the normalized, codified and categorized IMS 515 no matter what contextual color name is used to describe the product.

The claimed invention converts conventional SCM systems 510 and IMS 515 into an efficient color-based system that can be efficiently searched based on color and product categories. The claimed system normalizes, codifies and categorizes the data stored in the various SCM systems and IMS into colors based on the universal color code, and further categorizes the color normalized, codified and categorized data into product categories. Color is the only common denominator that all products have in common, the claimed invention provides a mechanism for searching based on the universal digital color code that is shared by the members of the supply chain management, including but not limited to merchants, manufacturers, distributors, retailers, component manufacturers, etc.

Since information relating to products provided by different Merchants is often expected to be formatted differently from one another, data received from various Merchants are transformed or normalized to a common format (e.g., an image of predetermined size, such as 500 pixels by 500 pixels), so that the information can be processed consistently and efficiently by the server 2800.

By utilizing the universal digital data-mapping color language model for a plurality of Merchants, the claimed invention resolves a significant hindrance to user searching for and finding products from different Merchants. Reverse mapping enables dynamic analysis and codification of precise color. When layered into proprietary Merchant IMS 515 and/or SCM systems 510, the search performed in accordance with an exemplary embodiment of the claimed invention is further enhanced as it no longer requires scraping the Internet. Likewise, the claimed invention ameliorates issues associated with Merchant product planning and production by providing them with standardized color information on sales, searches and availability.

In accordance with an exemplary embodiment of the claimed invention, as shown in FIG. 37, the server 2800 comprises one or more processors 2801, a color search engine 2802, a palette generator 2803, a machine learning and artificial intelligence (ML-AI) engine 2804, a user module 2805, a product recommendation engine 2806, a real-time analytics processor 2807, and an image processor 2808. The server 2800 obtains data from a variety of sources. In accordance with an exemplary embodiment of the claimed invention, the color palette generator 2803 of the server 2800 generates color palette based on the user's personal and demographic information, such as, but not limited to, name, location, birth date, preferred products, and preferred colors, obtained from a user/subscriber (or a different user/subscriber) by the user module 2805 of the server 2800. The processor 2801 of the server 2800 obtains data regarding products and inventories from Merchants' IMS 515 as part of the IMS feeds and/or from Merchants' SCM systems 510 as part of the SCM feeds, and the data may be in the form of text, images, videos, or some combination thereof.

Each data set introduced in the data warehouse 2810 represents interrelated data sets that communicate with and rely on other data sets for complete information (but do not necessarily represent discrete data sets). These data sets may be accessed using a variety of database management systems (DBMS), including but not limited to relational database management systems (RDBMS) and “post-relational” database management systems (e.g., not only Structured Query Language (“NOSQL”) database management systems. Furthermore, by using a DBMS such as RDBMS or a “post-relational” DBMS, the data may be available to a Merchant in a variety of manners, such as based on a specific demographic profile or a specific color or color grouping.

In general, data is received from a variety of sources, with at least some or all data/content received using live feeds from sources. Results may be sent to a variety of destinations, all related to combinations of consumer preferences, Merchant inventory, recent activity, and transactions. The sources of data include stores, including their inventory on-hand in various stores and on order, other Merchants and their facilities, and portions of a store or Merchant's supply chain, such as manufacturers and designers of the goods sold by the stores/Merchants, and preferably, including live feeds from each. Data sources also include consumers and financial institutions, as well as other independent sources (such as but not limited to news, weather, and media feeds). At least some of the data are received or obtained in real time by the data warehouse 2810, preferably using live feeds. The real-time analytics processor 2807 can perform analysis on demand or even as the data is being received by the server 2800 and the data warehouse 2810. The real-time analytics processor 2807 delivers the results of the analysis in near real-time, even while the consumer is in the midst of shopping, such as delivering guidance to consumers as they shop based on recent inventory changes.

In accordance with an exemplary embodiment of the claimed invention, the processor-executable or computer-executable instructions may be stored on a non-transitory computer-readable medium, such as a CD, DVD, flash memory, or the like. The processor-executable or computer-executable instructions may also be stored as a set of downloadable processor-executable or computer-executable instructions, for example, or downloading and installing from an Internet location (e.g., Web server).

The accompanying description and drawings only illustrate several embodiments of a system, methods and interfaces for color-based identification, searching and matching, however, other forms and embodiments are possible. Accordingly, the description and drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. A computer-implemented method for mapping a RGB (red, green, blue) digital color space into smaller, more efficient subsets of the RGB digital color space, comprising:
mathematically mapping the smaller subsets of the RGB digital color space into a three-dimensional cube model, sides and layers of the three-dimensional cube model become progressively smaller until all sides and layers converge at a center point of the three-dimensional cube model to form a three-dimensional nesting cube;
mathematically consolidating coordinates in a standard RGB (sRGB) digital color space that are not distinguishable to a human eye to an appropriate individual mapping cube to provide a color data visualization that is understandable to both a human being and a machine;
organizing the three-dimensional nesting cube into equidistant and individual nesting cubes to obtain a normalized three-dimensional nesting cube, each individual cube of the three-dimensional normalized nesting cube representing a unique and recognizable data mapping code that corresponds to a universal digital small language color model;
mathematically slicing the normalized three-dimensional nesting cube into connecting two-dimensional slices, each two-dimensional slice forming a grid mapping the normalized three-dimensional nesting cube to a hue axis corner, a longitude representing a horizontal movement within the grid, a latitude representing a vertical movement within the grid, and a layer representing an equidistant division of corners and midpoint of the grid to the center point of the normalized three-dimensional nesting cube;
wherein the unique data mapping code of the normalized three-dimensional nesting cube is defined by the grid mapping to the hue axis corner, the longitude, the latitude and the layer; and
aligning the color data visualization between a physical product to a digital image that represents the physical product with the unique and recognizable data mapping code that corresponds to the universal digital small language color model by:
normalizing a raw RGB image color into a smaller, more efficient subset of sRGB digital color space;
adhering sticky contextual product data to the unique and recognizable data mapping code that corresponds to the universal digital small language model;
bucketing structured and unstructured product data into an individual nesting cube of the normalized three-dimensional nest cube to filter and structure the product data;
bucketing structured and unstructured user and user preference data based on color-based product search queries into said individual nesting cube of the normalized three-dimensional nesting cube to filter and structure the user data; and
utilizing the filtered and structured product and user data for hyper-personalized search, data analytics, data marketing, and concierge sale service.

2. The method of claim 1, wherein the normalized three-dimensional nesting cube comprises following six hue axis corners: a red side with a red hue axis corner, a yellow side with a yellow hue axis corner, a green side with a green hue axis corner, a cyan side with a cyan hue axis corner, a blue side with a blue hue axis corner, and a magneto side with a magneto hue axis corner.

3. The method of claim 2, further comprising embedding product metadata to the unique data mapping code extracted from the digital image of the physical product and uploading the digital image of the physical product embedded with the product metadata to an eCommerce platform.

4. The method of claim 3, further comprising homogenizing color data across the eCommerce platform to provide a homogenized eCommerce platform by: matching a digital image of each physical product offered in the eCommerce platform to the unique data mapping code that corresponds to the universal digital small language color model; embedding the product metadata to the digital image of said each physical product; and uploading the digital image of said each physical product embedded with the product metadata to the eCommerce platform.

5. The method of claim 4, further comprising displaying a graphical user interface with a normalized color palette of the data mapping code that corresponds to universal digital small color language model to an online shopper on the homogenized eCommerce platform so that the online shopper can search for a desired product by the normalized color palette of the data mapping code that corresponds to the universal digital small color language model.

6. The method of claim 5, further comprising utilizing the normalized three-dimensional nesting cube and the universal digital small color language model to collect an interaction of the online shopper with the homogenized eCommerce platform to collect, filter, and structure the user preference data and the product data.

7. The method of claim 6, further comprising utilizing the normalized three-dimensional nesting cube and the universal digital small color language model by a machine learning and artificial intelligence engine to collect and filter the product data, the user data and the user preference data generated by the interaction of the online shopper with the homogenized eCommerce platform and to coordinate products on the homogenized eCommerce platform; and generating hyper-personalized and color-coordinated product suggestions based on the data mapping code of the desired product.

8. The method of claim 1, further comprising assigning the unique data mapping code that corresponds to the universal digital color language model to a physical product that is closest to an individual nesting cube of the normalized three-dimensional color nesting cube based on color component intensity values for at least one dominant color of the physical product.

9. The method of claim 8, further comprising generating retail data analytics and personalized data marketing to online shoppers based on search results and shopping history on an eCommerce platform by a machine learning and artificial intelligence engine.
